(19) United States
(12) Patent Application Publication
(10) Pub. No.: US 2016/0174285 A1
(43) Pub. Date: Jun. 16, 2016

(54) METHOD FOR MAINTAINING SERVICE CONTINUITY IN HETEROGENEOUS COMMUNICATIONS SYSTEM

(71) Applicant: SAMSUNG ELECTRONICS CO., LTD., Gyeonggi-do (KR)

(72) Inventors: Xiaowan Ke, Beijing (CN); Lixiang Xu, Beijing (CN); Hong Wang, Beijing (CN)

(21) Appl. No.: 14/909,726

(22) PCT Filed: Aug. 1, 2014
(86) PCT No.: PCT/KR2014/007102

§ 371 Date: Feb. 2, 2016

(30) Foreign Application Priority Data
Aug. 2, 2013 (CN) 201310334369.1

(51) Int. Cl. H04W 76/04; H04W 8/02

(52) U.S. Cl. CPC H04W 76/045; H04W 8/02

(57) ABSTRACT

Embodiments of the present disclosure provide a method for maintaining service continuity in heterogeneous communication system, including: when a bearer is established on a SeNB/SeNB's cell for a UE or the UE tracking area is updated due to a bearer transfer, a MeNB sends a MME a serving identifier of a SeNB/SeNB's cell where the UE is located or a serving identifier of a eNB/cell which a user plane bearer of the UE is on; the MME determines a TA identifier/eNB identifier which the UE bearer is in, including a TA identifier/eNB identifier of the SeNB's cell where the UE is located, according to received serving identifier. On one hand, the MME may determine whether a UE moves out of the local home network according to the TA of the UE, and whether it is necessary to release the SIPTO@LN bearer. On the other hand, the MME may select the SGW according to the TA identifier/eNB identifier and the TA identifier/eNB identifier of a MeNB/MeNB's cell, or according to the TA identifier/eNB identifier where a user plane bearer of the UE is located, and notify the MeNB, so that the MeNB may, according to corresponding notification, establish or remain a UE bearer on the SeNB's cell, or transfer a UE bearer in or out of the SeNB's cell. By adopting above method, the continuity of user plane data may be maintained when a bearer is established on or moved to a small cell.

### TECHNICAL FIELD

The present disclosure relates to wireless communication technology, and more particularly, to a method for maintaining service continuity in heterogeneous communication system.

### BACKGROUND ART

The modern mobile communication tends to provide multimedia services with high rate transmission for users. FIG. 1 is a schematic diagram illustrating the architecture of a System Architecture Evolution (SAE) system.

In FIG. 1, a User Equipment (UE) 101 is a terminal device for receiving data. An Evolved Universal Terrestrial Radio Access Network (E-UTRAN) 102 is a radio access device, including a macro NodeB (eNodeB/NodeB) for providing an interface for accessing radio network for the UE. A Mobility Management Entity (MME) 103 is adapted to manage mobile contexts, session contexts and security information of the UE. A Serving Gateway (SGW) 104 is mainly adapted to provide functions of a user plane. The MME 103 and the SGW 104 may be located in the same physical entity. A Packet Gateway (PGW) 105 is adapted to implement charging and legal monitoring functions. The PGW 105 and the SGW 104 may be located in the same physical entity. A Policy and Charging Rules Function (PCRF) 106 is adapted to provide QoS policies and charging rules. A Service GPRS Supporting Node (SGSN) 108 is a network node device for providing routing for data transmission in a Universal Mobile Telecommunications System (UMTS). A Home Subscriber Server (HSS) 109 is a home subsystem of the UE and is adapted to protect user information including the current location of the UE, the address of a serving node, user security information and packet data contexts of the UE.

In 3rd Generation Partnership Project (3GPP) Release 12 (Rel-12), requirements of small cell enhancement are proposed. Target scenarios of the small cell enhancement include scenarios with macro cell coverage and without macro cell coverage, indoor and outdoor, ideal and non-ideal backhaul enhancement, as shown in FIG. 2.

For the scenario with macro cell coverage, it is provided that the carrier aggregation technology inter-eNodeB s (eNB s) may be applied, and a macro cell and a small cell may provide services for a UE at the same time by working at different frequencies. The macro cell is a primary cell (Pcell), and the small cell is a secondary cell (Scell). The Pcell is a serving cell of the UE, and is adapted to provide a RRC control of the UE; and the Scell is adapted to provide a supplemental bearer. There are multiple architectures of conventional carrier aggregation technology among different eNBs. For example, the architecture based on the Radio Access Network (RAN) split and the architecture based on the Core Network (CN) split, as shown in FIG. 3. The architecture of the carrier aggregation inter-eNBs based on the Radio Access Network (RAN) split refers to the following. A serving eNB of the Pcell of the UE is a master eNB (MeNB), and may control to establish a UE bearer on a cell of the MeNB (MeNB cell or MeNB's cell) or a cell of a secondary eNB (SeNB cell or SeNB's cell). The cell of the SeNB is called a Scell of the UE. That is to say, the MeNB is the serving eNB of the Pcell, and the Pcell is a primary cell on the MeNB. For the bearer established on the Scell, the data came from a SGW of the CN needs to be forwarded by the MeNB to the SeNB, and sent by the SeNB to the UE. The architecture based on the Core Network (CN) split refers to the following. For the bearer established on the Scell, the data came from the SGW of the CN may be directly sent to the SeNB, and then sent by the SeNB to the UE. The user plane data is not forwarded through the MeNB.

### DISCLOSURE OF INVENTION

### Technical Problem

For the architecture based on the Core Network (CN) split, there are the following problems.

1) There may not be a connection between the SeNB and the SGW connected with the MeNB. For example, when the Tacking Area (TA) of the Pcell of the MeNB (MeNB Pcell or MeNB's Pcell) of the UE and the TA of the Scell of the SeNB (SeNB Scell or SeNB's Scell) of the UE are different, and when the MeNB establishes a UE bearer on the Scell of the SeNB or transfers a UE bearer to the SeNB Scell, the serving cell of control plane of the UE is still the MeNB Pcell of the UE, the UE may ignore the TA broadcasted by the SeNB Scell, and deem that the UE is still attached to the TA of the MeNB Pcell of the UE. However, when the TA of the SeNB Scell is not in the serving scope of current SGW or the SeNB is not connected with the current SGW, the UE will not trigger a Tracking Area Update (TAU) resulted from newly adding a TA, and the MME will deem that the TA which the UE has access to is still in the serving scope of the current SGW, which will result in the UE bearer on the SeNB Scell is interrupted.

2) When the MeNB Pcell of the UE only provides control plane, all user plane bearers are established on the SeNB Scell, and the TA of the MeNB Pcell and the TA of the SeNB Scell of the UE are different, if the SGW selected by the MME according to the TA of the MeNB Pcell of the UE is not connected with the SeNB, all of the user plane bearers of the UE will be interrupted.

3) When the SeNB provides a local home network SIPTO@LN service, and after the UE establishes a SIPTO@LN bearer on a SeNB Scell, the UE moves out of the local home network but is still in the coverage of the MeNB Pcell of the UE, because the TAU of the UE still indicates that the UE is still attached to the TA of the MeNB Pcell of the UE, there is no S1 message to notify the MME that the UE has shifted out of the local home network, and the MME will be unable to properly release the SIPTO@ LN service.

4) For a bearer established on the SeNB Scell, when it is occurs that the SGW triggered by the MME is relocated, there is no definition about how to inform the SeNB of a new transport layer address and a GPRS tunneling protocol-tunnel endpoint ID (GTP-TEID) of the SGW.

5) If the MME triggers the SGW relocation for load balancing, because the MME only knows the TA of the MeNB Pcell of the UE and does not know the TA of the SeNB Scell, new SGW selected according to the TA of the MeNB Pcell of the UE may have no connection with the SeNB, which may lead to that the UE bearer on the SeNB Scell may be interrupted.

6) When the SeNB and the MeNB compose a local home network and provide a SIPTO@LN service, the MeNB may be connected with multiple local home networks. When the UE establishes a SIPTO@LN bearer on a SeNB Scell in a first local home network, for optimal routing, the MME selects a SGW of the first local home network for the UE as the serving SGW of the UE. When the UE moves out of the SeNB Scell of the first local home network, the MeNB may transfer the SIPTO@LN bearer in the first local home network to a MeNB Pcell of the UE, and may not release the SIPTO@LN bearer. When the UE moves in a SeNB Scell of a second local home network in the coverage of the MeNB Pcell of the UE, the MME may transfer a common Public Data Network (PDN) bearer to a SeNB Scell in the second local home network or establishes a common PDN bearer on the SeNB Scell in the second local home network, because there is no connection between the SGW of the first local home network and the SeNB of the second local home network or the TA of the second local home network is not belong to the serving scope of the SGW of the first local home network, the MME only knows the TA of the MeNB Pcell of the UE and does not know the TA of the SeNB Scell, which may lead to that the bearer established on or moved to the SeNB Scell of the second local home network may be interrupted.

7) When the SeNB and the MeNB compose a local home network and provide a SIPTO@LN service, for a common PDN, when the UE accesses to the local home network, the MME may randomly select a local SGW or a macro network SGW as the serving SGW according to the TA which the UE has access to. However, when the MeNB establishes the common PDN bearer on the SeNB Scell of the second local home network, if there is a SIPTO@LN bearer of the first local home network on the MeNB Pcell of the UE, and the MME reselect one SGW according to the TA of the MeNB Pcell of the UE and the TA of the SeNB Scell of the UE, it is required to exclude the SGW of the second local home network. Because there is no connection between the SGW of the second local home network and a Local Gateway (LGW) of the first local home network, which may lead to that the SIPTO@LN bearer of the first local home network on the MeNB Pcell of the UE may be interrupted.

8) When the SeNB and the MeNB compose a local home network and provide a SIPTO@LN service, if the UE initiates a SIPTO@LN bearer establishment request in the second local home network, and there is a SIPTO@LN bearer of the first local home network on the MeNB Pcell of the UE, the MME may release the first local home network bearer, and select a SGW of the second local home network for the UE according to the optimal routing principle.

### Solution to Problem

In order to achieve above mentioned objective, the present disclosure adopts the following technical solutions.

The method for maintaining service continuity in heterogeneous communication system provided by embodiments of the present disclosure includes:

a) sending, by a master eNB (MeNB) of a UE, a mobility management entity, MME, a serving identifier of a secondary eNB (SeNB) or a SeNB's cell where the UE is located, or a serving identifier of an eNB or a cell which a user plane bearer of the UE is on;

b) according to the serving identifier of the SeNB/SeNB's cell, determining, by the MME, a TA identifier or an eNB identifier supported by the SeNB/SeNB's cell where the UE is located; or, according to the serving identifier of the eNB/cell which the user plane bearer of the UE is on, determining, by the MME, a TA identifier or an eNB identifier supported by the eNB/cell which the user plane bearer of the UE is on;

c) according to the TA identifier or the eNB identifier of a SeNB/SeNB's cell where the UE is located, or according to the TA identifier or the eNB identifier supported by the eNB/cell which the user plane bearer of the UE is on, selecting, by the MME, a SGW, and notifying the MeNB of the SGW; and

d) according to a notification sent by the MME, establishing or remaining, by the MeNB, a UE bearer on the SeNB/SeNB's cell; or moving, by the MeNB, a UE bearer onto or out of the SeNB/SeNB's cell.

Preferably, wherein when selecting, by the MME, the SGW in step c), the method further comprises: selecting, by the MME, the SGW further according to a TA identifier or an eNB identifier of the MeNB or a MeNB's primary cell of the UE.

Preferably, wherein the SeNB/SeNB's cell where the UE is located is any one of the followings:

a SeNB/SeNB's cell on which a user plane bearer of the UE is established by the MeNB;

a SeNB/SeNB's cell, which the MeNB knows, according to a measurement report of the UE, that the UE is in the coverage of the SeNB/SeNB's cell; and

a SeNB/SeNB's cell which is in a coverage of the MeNB/MeNB's cell where the UE accesses.

Preferably, wherein the eNB/cell which the user plane bearer of the UE is on is any one of the followings:

a MeNB/SeNB or a MeNB's cell/SeNB's cell on which a user plane bearer of the UE is established under the control of the MeNB;

a MeNB/SeNB or a MeNB's cell/SeNB's cell, which the MeNB knows according to a measurement report of the UE, that the UE is in the coverage of the MeNB/SeNB or the MeNB's cell/SeNB s cell; and

a MeNB/SeNB or a MeNB's cell/SeNB's cell which is in a coverage of the MeNB/MeNB's cell where the UE accesses.

Preferably, the serving identifier is any one of the followings:

a TA identifier, a cell identifier, and an eNB identifier.

Preferably, wherein the serving identifier is a cell identifier; the method further includes:

when establishing a S1 interface with the MME, sending, by an eNB, a mapping relationship between a cell in the coverage of the eNB and a TA supported by the cell to the MME.

Preferably, when the TA of the SeNB/SeNB's cell where the UE is located is different from the TA supported by the MeNB/MeNB's primary cell of the UE, performing step a); or

when the target SeNB where the UE is located is different from the source SeNB where the UE is located, performing step a); or

when the TA of the target SeNB/SeNB's cell where the UE is located is different from the TA of the source SeNB/SeNB's cell where the UE is located, performing step a); or

when the SeNB/SeNB's cell where the UE is located is not in the scope indicated by the serving identifier supported by current SGW, performing step a).

Preferably, while sending, by the MeNB, the MME the serving identifier of the SeNB/SeNB's cell where the UE is located, sending, by the MeNB, the MME a serving identifier of a MeNB/MeNB's primary cell which the UE accesses to.

Preferably, wherein step a) further includes:

sending, by the MeNB, a local home network identifier of the SeNB/SeNB's cell where the UE is located and a local home network identifier of an eNB/cell which a user plane bearer of the UE is on.

Preferably, the method further includes:

obtaining, by the MeNB, the serving identifier or the local home network identifier of the SeNB/SeNB's cell via an interface between the MeNB and the SeNB.

Preferably, when there is a SIPTO@LN PDN bearer of the first local home network in the MME, and the local home network identifier of the SeNB/SeNB's cell sent by the MeNB indicates a second local home network, and if the MeNB/MeNB's primary cell which the UE accesses to belongs to the first local home network and the UE does not initiate a new SIPTO@LN PDN connection establishment request, when selecting, by the MME, the SGW in step c), not selecting, by the MME, a SGW of the second local home network.

Preferably, when there is a SIPTO@LN PDN bearer of the first local home network in the MME, and the local home network identifier of the SeNB/SeNB's cell sent by the MeNB indicates a second local home network, and if the MeNB/MeNB's primary cell which the UE accesses to belongs to the first local home network and the UE initiates a new SIPTO@LN PDN connection establishment request, the method further comprises:

releasing, by the MME, the SIPTO@LN PDN bearer of the first local home network.

Preferably, when there is a SIPTO@LN PDN bearer of the first local home network in the MME, and the local home network identifier of the SeNB/SeNB's cell sent by the MeNB indicates a second local home network, and if the MeNB/MeNB's primary cell which the UE accesses to does not belong to the first local home network, the method further comprises:

releasing, by the MME, the SIPTO@LN PDN bearer of the first local home network.

Preferably, wherein step c) includes:

when there is no SGW supporting both the TA identifier or eNB identifier of the MeNB/MeNB's primary cell where the UE is located and the TA identifier or eNB identifier determined in step b), selecting, by the MME, a SGW supporting the TA identifier or eNB identifier of the MeNB/MeNB's primary cell, or a SGW supporting the TA identifier or eNB identifier determined in step b); or

notifying, by the MME, the MeNB, that it is not supported to establish a UE bearer on both the MeNB/MeNB's primary cell which the UE accesses to and the SeNB/SeNB's cell where the UE is located; or notifying, by the MME, the MeNB, that which user plane bearers of the UE are to be moved in or out of the SeNB/SeNB's cell; or notifying, by the MME, to the MeNB, that which user plane bearers of the UE are to be moved in or out of the MeNB/MeNB's primary cell; and/or,

when there is a SGW supporting both the TA identifier or eNB identifier of the MeNB/MeNB's primary cell where the UE is located and the TA identifier or eNB identifier determined in step b), selecting, by the MME, the SGW as the serving SGW of the UE, and notifying, by the MME, the MeNB of a TA identifier list or an eNB identifier list supported by selected SGW; and/or,

when there is no SGW supporting all TA identifiers or eNB identifiers of eNBs/cells which the user plane bearers of the UE are in, selecting, by the MME, a SGW supporting part of the TA identifiers or eNB identifiers of eNB s/cells which the user plane bearers of the UE are in; or instructing, by the MME, the MeNB that it is not supported to establish a UE bearer on all TAs/eNBs which the user plane bearers of the UE are in; or, notifying, by the MME, the MeNB that which user plane bearers of the UE is to be moved out of which TAs/eNBs or into which TAs/eNBs.

Preferably, wherein when selecting, by the MME, a SGW supporting the TA identifier or eNB identifier of the MeNB/MeNB's primary cell, or a SGW supporting the TA identifier or eNB identifier determined in step b), step c) further comprises: sending, by the MME, TA identifiers/eNB identifiers supported by selected SGW or TA identifiers/eNB identifiers unsupported by the selected SGW to the MeNB; and/or

when selecting, by the MME, a SGW supporting part of the TA identifiers or eNB identifiers of eNB s/cells which the user plane bearers of the UE are in, step c) further comprises: sending, by the MME, TA identifiers/eNB identifiers supported by selected SGW or TA identifiers/eNB identifiers unsupported by the selected SGW to the MeNB.

Preferably, wherein step d) includes:

when the notification sent by the MME comprises a new SGW transport layer address and/or a GTP-TEID, for an affected UE bearer, updating, by the MeNB, a SeNB on which the corresponding UE bearer is established, with the new SGW transport layer address and/or the GTP-TEID; and/or,

when the notification sent by the MME comprises a list comprising TA identifiers/eNB identifiers supported by selected SGW or TA identifiers/eNB identifiers unsupported by the selected SGW, determining, by the MeNB, a TA/eNB/cell supported and unsupported by the selected SGW according to the list; moving, by the MeNB, a user plane bearer of the UE on a TA/eNB/cell unsupported by the selected SGW to a TA/eNB/cell supported by the selected SGW; establishing, by the MeNB, a user plane bearer of the UE on a TA/eNB/cell supported by the selected SGW; and/or,

when the MME notifies the MeNB that it is not supported to simultaneously establish a UE bearer on the MeNB/MeNB's primary cell which the UE accesses to and on the SeNB/SeNB's cell where the UE is located, moving out, by the MeNB, an UE bearer on the SeNB/SeNB's cell; or, moving out, by the MeNB, an UE bearer on the MeNB/MeNB's cell; and/or,

when the MME notifies the MeNB that it is not supported to simultaneously establish UE bearers on all TAs/eNBs which user plane bearers of the UE are in, moving out, by the MeNB, an UE bearer on the SeNB/SeNB's cell; or, moving out, by the MeNB, an UE bearer on the MeNB/MeNB's primary cell; and/or,

when the MME notifies the MeNB that it is supported to simultaneously establish a bearer on the MeNB/MeNB's primary cell of the UE and on the SeNB/SeNB's cell where the UE is located, simultaneously establishing or moving, by the MeNB, a UE bearer on the TA/eNB of the MeNB/MeNB's primary cell of the UE and on the TA/eNB of the SeNB/SeNB's cell where the UE is located; or when the MME notifies that it is supported to simultaneously establish a UE bearer on all cells which the user plane bearers of the UE are in, simultaneously establishing or moving, by the MeNB, a UE bearer on all TAs/eNBs of cells which the user plane bearers of the UE are in;

when the MME notifies the MeNB of the TA identifier list/eNB identifier list supported by the selected SGW, and selecting, by the MeNB, a SeNB/SeNB's cell supporting the TA identifier list/eNB identifier list when selecting a SeNB/SeNB's cell for the UE to establish or move a UE bearer.

Preferably, the method further includes:

when the MeNB adds a SeNB/SeNB's cell for the UE and sends the UE a SeNB/SeNB's cell configuration, the SeNB/SeNB's cell configuration comprises the TA identifiers/eNB identifiers supported by the SeNB/SeNB's cell.

Another method for maintaining service continuity in heterogeneous communication system provided by embodiments of the present disclosure, includes:

a) obtaining, by a UE, a TA identifier/eNB identifier of a SeNB/SeNB's cell where the UE is located from a MeNB or a SeNB;

b) initiating, by the UE, an attach request, a tracking area update request, or a service request; forwarding, by the MeNB, the attach request, tracking area update request or service request of the UE to a MME; wherein the attach request, tracking area update request or service request carries the TA identifier/eNB identifier of the SeNB/SeNB's cell where the UE is located, or the attach request, tracking area update request or service request carries an TA identifier/eNB identifier which a user plane bearer of the UE is in; or sending, by the UE, the TA identifier/eNB identifier of the SeNB/SeNB's cell obtained by the UE to the MME;

c) selecting, by the MME, a SGW according to the TA identifier/eNB identifier of the SeNB/SeNB's cell, or according to the identifier of the TA identifier/eNB identifier which the user plane bearer of the UE is in; and

d) according to a notification sent by the MME, establishing or remaining, by the MeNB, a UE bearer on the SeNB/SeNB's cell; or moving, by the MeNB, a UE bearer onto or out of the SeNB/SeNB's cell.

Preferably, wherein when selecting, by the MME, the SGW in step c), the method further comprises: selecting, by the MME, the SGW further according to a TA identifier or an eNB identifier of the MeNB or a MeNB's primary cell of the UE.

Preferably, wherein obtaining, by the UE, the TA identifier/eNB identifier of the SeNB/SeNB's cell from the MeNB comprises: when adding, by the MeNB, a SeNB/SeNB's cell configuration for the UE, sending, by the MeNB, a TA identifier/eNB identifier of added SeNB/SeNB's cell to the UE;

wherein obtaining, by the UE, the TA identifier/eNB identifier of the SeNB/SeNB's cell from the SeNB comprises: when receiving, by the UE, a SeNB/SeNB's cell configuration added by the MeNB, according to a received physical cell identifier, indexing, by the UE, a system information broadcasted by a cell of the SeNB, and obtaining, by the UE, the TA identifier/eNB identifier of the SeNB/SeNB's cell from the system information.

Preferably, wherein step c) includes:

when there is no SGW supporting both the TA identifier/eNB identifier of the MeNB/MeNB's primary cell where the UE is located and the TA identifier/eNB identifier carried in step b), selecting, by the MME, a SGW supporting the TA identifier/eNB identifier of the MeNB/MeNB's primary cell, or a SGW supporting the TA identifier/eNB identifier carried in step b); or notifying, by the MME, the MeNB, that it is not supported to establish a UE bearer on both the MeNB/MeNB's cell which the UE accesses to and the SeNB/SeNB's cell where the UE is located; or notifying, by the MME, the MeNB, that which user plane bearers of the UE are to be moved out of which TAs/eNBs; or notifying, by the MME, the MeNB, that which user plane bearers of the UE are to be moved in which TAs/eNBs; and/or,

when there is a SGW supporting both the TA identifier/eNB identifier of the MeNB/MeNB's primary cell where the UE is located and the TA identifier/eNB identifier carried in step b), selecting, by the MME, the SGW as the serving SGW of the UE, and notifying, by the MME, the MeNB of a TA identifier list/eNB identifier list supported by selected SGW; and/or,

when there is no SGW supporting all TA identifiers/eNB identifiers which the user plane bearers of the UE are in, selecting, by the MME, a SGW supporting part of the TA identifiers/eNB identifiers which the user plane bearers of the UE are in; or instructing, by the MME, the MeNB that it is not supported to simultaneously establish a UE bearer on all TAs/eNBs which the user plane bearers of the UE are in; or, notifying, by the MME, the MeNB that which user plane bearers of the UE are to be moved out of which TAs/eNBs and into which TAs/eNBs.

Preferably, wherein when selecting, by the MME, the SGW supporting the TA identifier/eNB identifier of the MeNB/MeNB's primary cell, or a SGW supporting the TA identifier/eNB identifier carried in step b), step c) further comprises: sending, by the MME, TA identifiers/eNB identifiers supported by selected SGW or TA identifiers/eNB identifiers unsupported by the selected SGW to the MeNB; and/or when selecting, by the MME, a SGW supporting part of the TA identifiers/eNB identifiers which the user plane bearers of the UE are in, step c) further comprises: sending, by the MME, TA identifiers/eNB identifiers supported by selected SGW or TA identifiers/eNB identifiers unsupported by the selected SGW to the MeNB.

Preferably, wherein step d) includes:

when the notification sent by the MME comprises a new SGW transport layer address and/or a GTP-TEID, for an affected UE bearer, updating, by the MeNB, a SeNB on which the corresponding UE bearer is established, with the new SGW transport layer address and/or the GTP-TEID; and/or,

when the notification sent by the MME comprises a list comprising TA identifiers/eNB identifiers supported by selected SGW or TA identifiers/eNB identifiers unsupported by the selected SGW, determining, by the MeNB, TA identifiers/eNB identifiers supported and unsupported by the selected SGW according to the list; moving, by the MeNB, a user plane bearer of the UE on a cell/eNB corresponding to a TA identifier/eNB identifier unsupported by the selected SGW to a cell/eNB corresponding to a TA identifier/eNB identifier supported by the selected SGW; establishing, by the MeNB, a user plane bearer of the UE on a cell/eNB corresponding to a TA identifier/eNB identifier supported by the selected SGW; and/or,

when the MME notifies the MeNB that it is not supported to simultaneously establish a UE bearer on the MeNB/MeNB's primary cell which the UE accesses to and on the SeNB/SeNB's cell where the UE is located, moving out, by the MeNB, an UE bearer on the SeNB/SeNB's cell; or, moving out, by the MeNB, an UE bearer on the MeNB/MeNB's primary cell; and/or,

when the MME notifies the MeNB that it is not supported to simultaneously establish UE bearers on all TAs/eNBs which the user plane bearers of the UE are in, moving out, by the MeNB, an UE bearer on the SeNB/SeNB's cell; or, moving out, by the MeNB, an UE bearer on the MeNB/MeNB's primary cell; and/or,

when the MME notifies the MeNB that it is supported to simultaneously establish a UE bearer on the MeNB/MeNB's primary cell of the UE and on the SeNB/SeNB's cell where the UE is located, simultaneously establishing or moving, by the MeNB, a UE bearer on the TA/eNB of the MeNB/MeNB's primary cell of the UE and on the TA/eNB of the SeNB's cell where the UE is located; or when the MME notifies that it is supported to simultaneously establish a UE bearer on all cells which the user plane bearers of the UE are in, simultaneously establishing or moving, by the MeNB, a UE bearer on all TAs/eNBs of cells which the user plane bearers of the UE are in;

when the MME notifies the MeNB of the TA identifier list/eNB identifier list supported by the selected SGW, and selecting, by the MeNB, a SeNB/SeNB's cell supporting the TA identifier list/eNB identifier list when selecting a SeNB/SeNB's cell for the UE to establish or transfer a UE bearer.

Yet another method for maintaining service continuity in heterogeneous communication system, including:

selecting, by a MME, a serving SGW for a UE, and notifying a MeNB of the UE of a serving identifier list supported by selected SGW;

when selecting a SeNB/SeNB's cell for the UE, the MeNB selects a SeNB/SeNB's cell supporting a serving identifier in the serving identifier list to establish a user plane bearer of the UE.

Preferably, when the MME determines that the MeNB supports the capacity for providing dual-connectivity for the UE, notifying, by the MME, the MeNB of the serving identifier list; or

sending, by the MeNB, a request to the MME for requesting the MME to notify the MeNB of the serving identifier list.

Preferably, the MME determines whether the MeNB supports the capacity for providing dual-connectivity for the UE through one of the following methods: the MME knows whether the MeNB supports the capacity for providing dual-connectivity for the UE via an OAM; the MeNB notify the MME whether the MeNB supports the capacity for providing dual-connectivity for the UE.

Preferably, the method further includes: storing, by the MeNB, the serving identifier list supported by the serving SGW in the UE context.

Preferably, the serving identifier is a TA identifier, a cell identifier or an eNB identifier.

From the above technical solutions it can be seen that in the present disclosure, when a bearer is established on a cell of a SeNB for a UE or the UE location is updated result from the bearer transfer, the UE or the MeNB may send the MME a serving identifier of a SeNB's cell where the UE is located or a serving identifier of a cell where a user plane bearer of the UE is located, the MME may, according to received serving identifier, determine the SeNB's cell where the UE is located or a TA supported by the SeNB or the MME may determine the cell where the user plane bearer of the UE is located or a TA supported by a eNB of the cell. Subsequently, the MME may, according to determined TA, select a SGW, determine whether to establish or release a user plane bearer of the UE, and notify the MeNB, the MeNB may, according to corresponding notification, establish or remain a UE bearer on the Scell, or transfer a UE bearer in or out of the Scell. By adopting above method, the MME can obtain the TA of the SeNB's cell, and select the SGW according to the TA of the SeNB, or according to the TA of a cell where a user plane bearer of the UE is located and the TA of an eNB, so that the continuity of user plane data may be maintained when a bearer is established on or moved to a small cell. In addition, according to a TA of the UE, it may be determined that whether the UE moves out the local home network and whether it is necessary to release the SIPTO@LN bearer.

### Advantageous Effects of Invention

In view of above, embodiments of the present disclosure provide a method for maintaining service continuity in heterogeneous communication system, which can maintain the continuity of user plane data when a bearer is established on or moved to a small cell, thus when a UE moves under the small cell scenario, the proper processing of bearer shunt may be guaranteed. On one hand, the data rate which the UE perceives may be increased, and the user experience may be improved, on the other hand, the data lost may be avoided, and the service continuity may be maintained.

### BRIEF DESCRIPTION OF DRAWINGS

FIG. 1 is a schematic diagram illustrating the architecture of an existing SAE system;

FIG. 2 is a schematic diagram illustrating a deployment scenario of small cell enhancement;

FIG. 3 is a schematic diagram illustrating the architecture of the CN split;

FIG. 4 is a flowchart illustrating a method for maintaining service continuity in heterogeneous communication system according to an embodiment of the present disclosure;

FIG. 5 is a flowchart illustrating a method for maintaining service continuity in heterogeneous communication system according to another embodiment of the present disclosure;

FIG. 6 is a flowchart illustrating a method for maintaining service continuity in heterogeneous communication system according to yet another embodiment of the present disclosure;

FIG. 7 is a flowchart illustrating a method for maintaining service continuity in heterogeneous communication system according to a first example of the present disclosure;

FIG. 8 is a flowchart illustrating a method for maintaining service continuity in heterogeneous communication system according to a second example of the present disclosure;

FIG. 9 is a flowchart illustrating a method for maintaining service continuity in heterogeneous communication system according to a third example of the present disclosure;

FIG. 10 is a flowchart illustrating a method for maintaining service continuity in heterogeneous communication system according to a fourth example of the present disclosure;

FIG. 11 is a flowchart illustrating a method for maintaining service continuity in heterogeneous communication system according to a fifth example of the present disclosure;

FIG. 12 is a flowchart illustrating a method for maintaining service continuity in heterogeneous communication system according to a sixth example of the present disclosure;

FIG. 13 is a flowchart illustrating a method for maintaining service continuity in heterogeneous communication system according to a seventh example of the present disclosure;

FIG. 14 is a flowchart illustrating a method for maintaining service continuity in heterogeneous communication system according to yet another embodiment of the present disclosure;

FIG. 15 is a flowchart illustrating a method for maintaining service continuity in heterogeneous communication system according to an eighth example of the present disclosure;

FIG. 16 is a flowchart illustrating a method for maintaining service continuity in heterogeneous communication system according to a ninth example of the present disclosure;

FIG. 17 is a flowchart illustrating a method for maintaining service continuity in heterogeneous communication system according to a tenth example of the present disclosure.

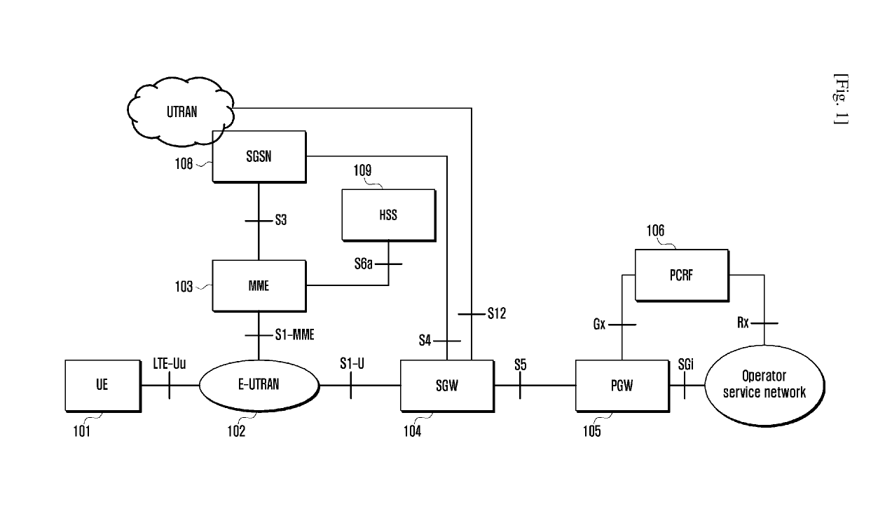

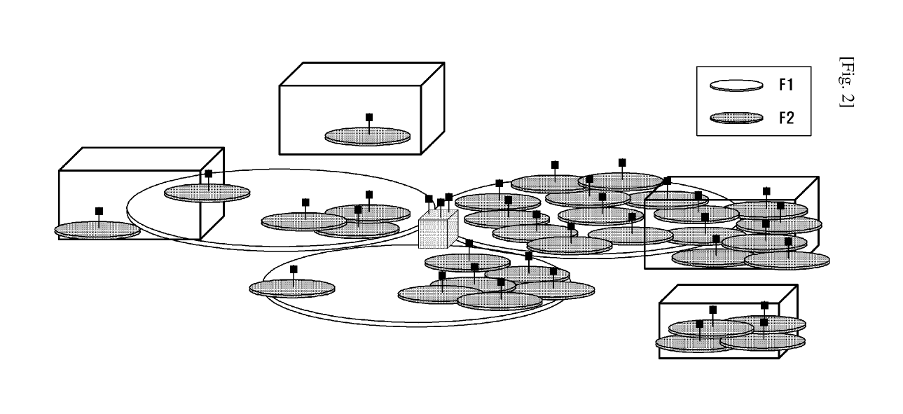

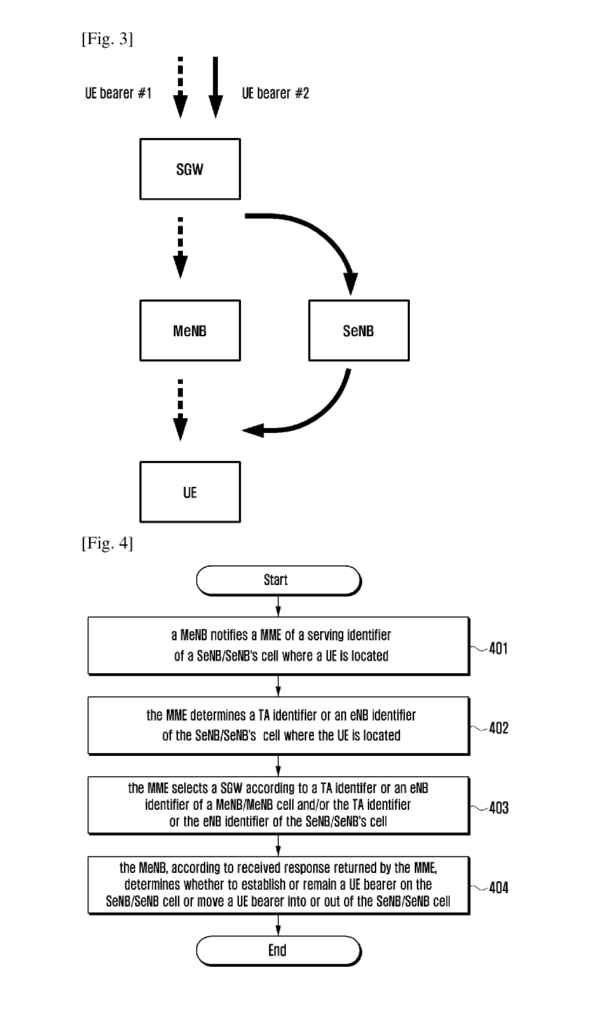

### MODE FOR THE INVENTION

In order to make objectives, technical solutions and advantages of the present disclosure clearer, the present disclosure will be described in detail hereinafter with reference to accompanying drawings. As used herein, the term “includes” means includes but not limited to, the term “including” means including but not limited to. The term “based on” means based at least in part on. In addition, the terms “a” and “an” are intended to denote at least one of a particular element. The symbol “/” means “or”.

In the present disclosure, the MeNB or the UE may send the MME a serving identifier of a SeNB's cell where the UE is located or a serving identifier of a cell where a user plane bearer of the UE is located, so that the MME may, according to received serving identifier, determine a TA of the SeNB's cell or a TA of the cell where the user plane bearer of the UE is located, and select a proper SGW for the UE according to determined TA and a TA of a Pcell, notify the MeNB to properly perform the establishment, transfer, and the like, of a UE bearer, so as to maintain the continuity of the user plane data when a bearer is established on or moved to a small cell. Specifically, the present disclosure provides four kinds of methods for maintaining service continuity. These methods will be described hereinafter.

FIG. 4 is a flowchart illustrating a method for maintaining service continuity in heterogeneous communication system according to an embodiment of the present disclosure. As shown in FIG. 4, the method includes the following operations.

In block 401, a MeNB of a UE notifies a MME of a serving identifier of a SeNB's cell or a SeNB where a UE is located. The serving identifier may be a TA identifier of the cell, a cell identifier or an eNB identifier.

The SeNB's cell or the SeNB where the UE is located may be a SeNB's cell or a SeNB on which a user plane bearer of the UE is established by the MeNB, or a SeNB's cell or a SeNB, which the MeNB knows, according to a measurement report of the UE, that the UE is in the coverage of the SeNB/SeNB's cell, or all SeNB's cell(s) or all SeNB(s) which are in the coverage of a MeNB Pcell or the MeNB where the UE accesses.

The MeNB may obtain information including an eNB identifier, a supported TA, a supported Public Land Mobile Network (PLMN), a supported local home network identifier (LHN ID) of the SeNB's cell or the SeNB, and so on, through an interface between the MeNB and the SeNB. The MeNB may obtain above mentioned information of the SeNB's cell or the SeNB through a X2 interface setup request/response message or an eNB configuration update message.

Furthermore, while the MeNB notifies the MME of the serving identifier of the SeNB's cell of the SeNB where the UE is located, the MeNB may also send a serving identifier of the MeNB Pcell or the MeNB which the UE accesses to. There may be the following two methods for sending, by the MeNB, the MME the serving identifier of the SeNB's cell or the SeNB where the UE is located and the serving identifier of the MeNB Pcell or the MeNB which the UE accesses to. 1) The MeNB may notify the MME of the serving identifier of the MeNB Pcell or the MeNB and/or serving identifiers of all SeNB's cells or all SeNBs in the coverage of the MeNB; or 2) the MeNB may notify the MME of only the serving identifier of the MeNB Pcell which the UE accesses to and/or the serving identifier of the SeNB's cell or the SeNB where the UE is located.

As previously mentioned, the serving identifier reported by the MeNB may be a TA identifier, a cell identifier or an eNB identifier. When the serving identifier is the TA identifier, the MeNB may notify the MME of the TA identifier of the MeNB Pcell and/or the TA identifier of the SeNB's cell only when the TA supported by the MeNB Pcell and the TA of the SeNB's cell are different. And when the TA supported by the MeNB Pcell is the same as the TA of the SeNB's cell, the MeNB may not send the TA identifiers, thus the system resources may be saved.

When the serving identifier of the SeNB's cell where the UE is located is a cell identifier, when establishing a S1 interface with the MME, an eNB (including the SeNB) may notify the MME of a mapping relationship between a cell and a TA supported by the cell. Thus, the MME may determine a TA corresponding to the cell identifier according the mapping relationship. Or the MME may derive the eNB identifier according to the cell identifier. The MME may further derive the TA supported by the eNB according to the eNB identifier.

Furthermore, when sending the serving identifier of the SeNB's cell or the SeNB where the UE is located, the MeNB may further notify the MME of a local home network identifier of the SeNB's cell where the UE is located, so as to resolve the problem that the local SIPTO@LN bearer cannot be properly released. The local home network identifier of the SeNB's cell where the UE is located may be a local home network identifier of a SeNB's cell on which a UE bearer is established by the MeNB, or a local home network identifier of a SeNB's cell, which the MeNB knows, according to a measurement report of the UE, that the UE is in the coverage of the SeNB's cell.

In order to further save the system resources, preferably, the MeNB may obtain, via the MME, the serving identifier scope supported by current SGW, when the SeNB's cell or the SeNB where the UE is located is in the serving identifier scope supported by the current SGW, the MeNB may not report the serving identifier of the SeNB's cell to the MME; otherwise, the MeNB report the serving identifier of the SeNB's cell to the MME.

When sending above mentioned serving identifiers to the MME, the MeNB may indicate that which serving identifiers are supported by the MeNB/MeNB's cell and which serving identifiers are supported by the SeNB/SeNB's cell. Or the MeNB may only provide a serving identifier list, and do not distinguish that which serving identifiers are supported by the MeNB/MeNB's cell and which serving identifiers are supported by the SeNB/SeNB's cell.

In block 402, the MME determines a TA identifier or an eNB identifier supported by the SeNB or SeNB's cell where the UE is located according to received serving identifier.

When the serving identifier is a TA identifier, the MME may directly determine the TA identifier supported by the SeNB's cell or the SeNB where the UE is located; or the MME may obtain an eNB identifier corresponding to the TA identifier according to a mapping relationship between an eNB identifier and a TA identifier.

When the serving identifier is a cell identifier, the MME may obtain the TA supported by the cell according a mapping relationship between the cell identifier and a TA; or the MME may derive the eNB identifier according to the cell identifier, and the MME may further derive the TA supported by the eNB according to the eNB identifier.

When the serving identifier is an eNB identifier, the MME may obtain the TA supported by the eNB according to a mapping relationship between the eNB identifier and a TA.

In block 403, the MME selects a SGW according to the TA identifier or the eNB identifier of the SeNB/SeNB's cell.

In the block, when selecting the SGW, the MME may select the SGW according to the TA identifier/eNB identifier of the SeNB/SeNB's cell; or the MME may select the SGW according to a TA identifier/eNB identifier of the MeNB/MeNB's cell and the TA identifier/eNB identifier of the SeNB/SeNB's cell. For example, the following processing may be further included in block 401. When all the user plane bearers of the UE are on the SeNB, the MeNB may instruct the MME to select the SGW according to only the TA identifier or the eNB identifier of the SeNB/SeNB's cell.

The MME may inquire available SGWs from a domain name system (DNS) according to above mentioned TA identifier or the eNB identifier, and after selecting a target SGW from the available SGWs and establishing a session, the MME may notify the MeNB of changing a bearer to the target SGW, and indicate the transport layer address of the SGW and/or the GTP-TEID.

If current serving SGW of the UE supports the TA identifier or the eNB identifier determined by the MME in block 402, the MME may not reselect the SGW and not return a bearer modification response to the MeNB.

When there is no SGW supporting both the TA or eNB identifier of the MeNB/MeNB Pcell and the TA or eNB identifier of the SeNB/SeNB's cell where the UE is located, the MME may select a SGW supporting the TA or eNB identifier of the MeNB/MeNB Pcell or select a SGW supporting the TA or eNB identifier of the SeNB/SeNB's cell. Furthermore, among all TA identifiers/eNB identifiers supported by MeNB/MeNB Pcell and SeNB/SeNB's cell, the MME may return TA identifiers/eNB identifiers supported by current SGW or selected SGW and TA identifiers/eNB identifiers unsupported by current SGW or selected SGW to the MeNB.

Or, when there is no SGW supporting both the TA or eNB identifier of the MeNB/MeNB Pcell and the TA or eNB identifier of the SeNB/SeNB's cell, the MME may instruct the MeNB not to support establishing a UE bearer on the MeNB/MeNB Pcell and the SeNB/SeNB's cell at the same time; or the MME may instruct the MeNB to transfer which user plane bearers of the UE in or out of the SeNB/SeNB's cell; or the MME may instruct the MeNB to transfer which user plane bearers of the UE out of the MeNB/MeNB Pcell of the UE.

When there is a SGW supporting both the TA or eNB identifier of the MeNB/MeNB Pcell and the TA or eNB identifier of the SeNB/SeNB's cell, the MME may preferably select the SGW supporting both the TA or eNB identifier of the MeNB/MeNB Pcell and the TA or eNB identifier of the SeNB/SeNB's cell. The MME may return a serving identifier list supported by selected SGW to the MeNB. The serving identifier may be TA identifier, cell identifier or eNB identifier. When selecting the SeNB/SeNB's cell for the UE, the MeNB may preferably select or only select the SeNB/SeNB's cell supporting the serving identifier.

Furthermore, if the MeNB notifies the MME of a local home network identifier (LHN ID) of the SeNB/SeNB's cell where the UE is located in block 401, when there is a SIPTO@LN PDN bearer of the first local home network in current MME, and the local home network identifier of the SeNB/SeNB's cell received by the MME indicates a second local home network, and if the MeNB/MeNB Pcell belongs to the first local home network and the UE does not initiate a new SIPTO@LN PDN connection establishment request, when selecting a SGW according to the TA of the MeNB/MeNB Pcell and the TA of the SeNB/SeNB's cell, the MME needs to exclude a SGW of the second local home network.

When there is a SIPTO@LN PDN bearer of the first local home network in current MME, and the local home network identifier of the SeNB/SeNB's cell received by the MME indicates a second local home network, and if the MeNB/MeNB Pcell belongs to the first local home network and the UE initiates a new SIPTO@LN PDN connection establishment request, the MME may release the SIPTO@LN PDN bearer of the first local home network.

When there is a SIPTO@LN PDN bearer of the first local home network in current MME, and the local home network identifier of the SeNB/SeNB's cell received by the MME indicates a second local home network, and if the MeNB/MeNB Pcell does not belong to the first local home network, the MME may release the SIPTO@LN PDN bearer of the first local home network.

By adopting above method, according to a TA of the UE, it may be determined that whether the UE moves out of the local home network and whether it is necessary to release the SIPTO@LN bearer.

In block 404, the MeNB, according to received response returned by the MME, determines whether to establish or remain a UE bearer on the SeNB/SeNB's cell or transfer a UE bearer into or out of the SeNB/SeNB's cell.

When receiving a new SGW transport layer address and/or a GTP-TEID, for an affected UE bearer, the MeNB needs to update a SeNB/SeNB Scell, on which the corresponding UE bearer is established, with the new SGW transport layer address and/or the GTP-TEID. The MeNB may send the new SGW transport layer address and/or the GTP-TEID to the SeNB through a bearer modification request/SeNB modification request.

In block 403, after selecting the SGW for the UE, the MME may send the MeNB a list including TA identifiers/eNB identifiers supported or unsupported by the SGW selected by the MME. In this case, the MeNB may determine TAs/eNB s/cells supported and unsupported by the selected SGW according to the list including the TA identifiers/eNB identifiers supported or unsupported by the SGW selected by the MME. The MeNB may transfer out user plane bearers of the UE on determined TAs/eNB s/cells unsupported by the SGW, or transfer the user plane bearers of the UE on determined TAs/eNB s/cells unsupported by the SGW onto determined TAs/eNB s/cells supported by the SGW. The MeNB may establish a new bearer of the UE on the determined TAs/eNB s/cells supported by the SGW.

There may be an auxiliary Pcell of the UE on the SeNB, and the SeNB auxiliary Pcell of the UE may provide internal control of the SeNB for the UE. The UE or MeNB or SeNB may take a TA supported by the SeNB auxiliary Pcell as the TA of the SeNB where the UE is located. When the SeNB auxiliary Pcell of the UE is supported by the SGW selected by the MME, the bearers of the UE may be established in all TAs of the SeNB.

When receiving an instruction from the MME that it is not supported to establish a UE bearer on the MeNB/MeNB Pcell of the UE which the UE accesses to and on the SeNB/SeNB's cell where the UE is located at the same time, the MeNB cannot establish a UE bearer on the MeNB/MeNB Pcell of the UE and on the SeNB/SeNB's cell at the same time, the MeNB may transfer out an existing UE bearer on the SeNB/SeNB's cell, or transfer out an existing UE bearer on the MeNB/MeNB Pcell of the UE. When it is supported to establish a UE bearer on the MeNB/MeNB Pcell of the UE which the UE accesses to and on the SeNB/SeNB's cell where the UE is located at the same time, the MeNB may simultaneously establish or transfer a UE bearer on the MeNB Pcell of the UE and on the SeNB/SeNB's cell.

When the response received by the MeNB and sent by the MME indicates a serving identifier list supported by current SGW, the MeNB may preferably select a SeNB/SeNB's cell supporting a serving identifier in the serving identifier list when selecting the SeNB/SeNB's cell for the UE to establish or transfer a UE bearer.

The first method for maintaining service continuity in heterogeneous communication system is terminated.

FIG. 5 is a flowchart illustrating a method for maintaining service continuity in heterogeneous communication system according to another embodiment of the present disclosure. As shown in FIG. 5, the method includes the following operations.

In block 501, a MeNB notifies a MME of a serving identifier of a cell which a user plane bearer of a UE is in.

The serving identifier may be a TA identifier, a cell identifier or an eNB identifier. The cell which the user plane bearer of the UE is in may be a MeNB's cell or a SeNB's cell on which the MeNB controls to establish a user plane bearer of the UE, or all MeNB's cell(s) and all SeNB's cell(s), which the MeNB knows, according to a measurement report of the UE, that the UE is in the coverage of the SeNB's cell.

When the serving identifier is a cell identifier, the following conditions may be satisfied. When establishing a S1 interface with the MME, an eNB (including the SeNB) may notify the MME of a mapping relationship between a cell and a TA supported by the cell. Thus, the MME may determine a TA corresponding to the cell identifier according the mapping relationship. Or, the MME may deduce an eNB identifier according to the cell identifier. The MME may further deduce a TA supported by the eNB according to the eNB identifier.

Furthermore, when sending the serving identifier of the cell which the user plane bearer of the UE is in, the MeNB may further notify the MME of a local home network identifier (LHN ID) of the SeNB's cell which the user plane bearer of the UE is in. The local home network identifier of the SeNB's cell which the user plane bearer of the UE is in may be a local home network identifier of a SeNB/SeNB's cell on which a UE bearer is established by the MeNB, or a local home network identifier of a SeNB's cell, which the MeNB knows, according to a measurement report of the UE, that the UE is in the coverage of the SeNB/SeNB's cell.

In order to further save the system resources, preferably, during the process of attaching, tracking area updating, service requesting or switching, when the target SeNB where the UE is located is different from the source SeNB where the UE is located, and the TA of the target SeNB's cell where the UE is located is different from the TA of the source SeNB's cell where the UE is located, the MeNB may notify the MME of a serving identifier of the cell which the user plane bearer of the UE is in. Or, if the MeNB may obtain the serving identifier scope supported by current SGW, when the cell which the user plane bearer of the UE is in belongs to the scope of serving identifier supported by the current SGW, the MeNB may not report the serving identifier of the cell which the user plane bearer of the UE is in to the MME; otherwise, the MeNB report the serving identifier of the cell which the user plane bearer of the UE is in to the MME.

In block 502, the MME determines a TA identifier/eNB identifier of the cell/eNB of the cell which the user plane bearer of the UE is in according to received serving identifier.

The specific description for block 502 may be the same as block 402, no further descriptions will be provided hereinafter.

In block 503, the MME selects a SGW according to the TA identifier/eNB identifier supported by the cell/eNB of the cell which the user plane bearer of the UE is in.

The MME may inquire available SGWs from a DNS according to above mentioned TA identifier or eNB identifier, and after selecting a target SGW from the available SGWs and establishing a session, the MME may notify the MeNB of changing a bearer to the target SGW, and indicate the transport layer address of the SGW and/or the GTP-TEID.

When current SGW of the UE supports the TA identifier or eNB identifier determined by the MME in block 502, the MME may not reselect the SGW and not return an E-RAB bearer modification response to the MeNB.

When there is no SGW supporting all TA identifiers of TAs which the user plane bearers of the UE are in or all eNB identifiers, the MME may select a SGW supporting part of the TA identifiers of TAs which the user plane bearers of the UE are in or a SGW supporting part of the eNB identifiers. Furthermore, among all TA identifiers of TAs which the user plane bearers of the UE are in and all eNB identifiers, the MME may notify the MeNB that which TA identifiers/eNB identifiers are supported by current SGW or selected SGW, and which TA identifiers/eNB identifiers are not supported by current SGW or selected SGW.

Or, when there is no SGW supporting all TA identifiers of TAs which the user plane bearers of the UE are in or all eNB identifiers, the MME may instruct the MeNB not to support establishing a UE bearer on all TAs which the user plane bearers of the UE are in or on all eNBs; or the MME may instruct the MeNB to transfer which user plane bearers of the UE out of which TAs or eNBs and into which TAs or eNBs.

When there is a SGW supporting all TA identifiers of TAs which the user plane bearers of the UE are in or all eNB identifiers, the MME may return a serving identifier list supported by selected SGW to the MeNB. The serving identifier may be TA identifier, cell identifier or eNB identifier. When selecting the SeNB/SeNB's cell for the UE, the MeNB may preferably select or only select the SeNB/SeNB's cell supporting the serving identifier.

Furthermore, if the MeNB notifies the MME of a local home network identifier of the cell which the user plane bearer of the UE is in block 501, when there is a SIPTO@LN PDN bearer of the first local home network in current MME, and the TA of the SIPTO@LN PDN bearer received by the MME is in the first local home network, the local home network of the cell which the user plane bearer of the UE is in is a second local home network, and the UE does not initiate a new SIPTO@LN PDN connection establishment request, when selecting a SGW according to the TA of the cell which the user plane bearer of the UE is in, the MME needs to exclude a SGW of the second local home network.

When there is a SIPTO@LN PDN bearer of the first local home network in current MME, and the TA of the SIPTO@LN PDN bearer received by the MME is in the first local home network, the local home network of the cell which the user plane bearer of the UE is in is a second local home network, and the UE initiates a new SIPTO@LN PDN connection establishment request, the MME may release the SIPTO@LN PDN bearer of the first local home network.

When there is a SIPTO@LN PDN bearer of the first local home network in current MME, and the TA of the SIPTO@LN PDN bearer received by the MME is not in the first local home network, the MME may release the SIPTO@LN PDN bearer of the first local home network.

In block 504, the MeNB, according to received response returned by the MME, determines whether to establish or transfer a user plane bearer of the UE between the MeNB Pcell of the UE and the SeNB's cell of the UE.

When receiving a new SGW transport layer address and/or a GTP-TEID, for an affected UE bearer, the MeNB needs to update a SeNB, on which the corresponding UE bearer is established, with the new SGW transport layer address. The MeNB may send the new SGW transport layer address and/or the GTP-TEID to the SeNB through a bearer modification request/SeNB modification request.

In block 503, after selecting the SGW for the UE, the MME may send the MeNB a list including TA identifiers/eNB identifiers supported or unsupported by the SGW selected by the MME. In this case, the MeNB may determine TA identifiers/eNB identifiers supported and unsupported by the selected SGW according to the list including the TA identifiers/eNB identifiers supported or unsupported by the SGW selected by the MME. The MeNB may transfer out user plane bearers of the UE on cells/eNBs corresponding to determined TA identifiers/eNB identifiers unsupported by the SGW, or transfer the user plane bearers of the UE on cells/eNBs corresponding to determined TA identifiers/eNB identifiers unsupported by the SGW onto cells/eNBs corresponding to determined TA identifiers/eNB identifiers supported by the SGW. The MeNB may establish a new bearer of the UE on cells/eNBs corresponding to the determined TA identifiers/eNB identifiers supported by the SGW.

There may be an auxiliary Pcell of the UE on the SeNB, and the SeNB auxiliary Pcell of the UE may provide internal control of the SeNB for the UE. The UE or MeNB or SeNB may take a TA supported by the SeNB auxiliary Pcell as the TA of the SeNB where the UE is located. When the SeNB auxiliary Pcell of the UE is supported by the SGW selected by the MME, the bearers of the UE may be established in all TAs of the SeNB.

When receiving an instruction from the MME that it is not supported to simultaneously establish UE bearers on all TAs which the user plane bearers of the UE are in or all eNBs, the MeNB cannot simultaneously establish UE bearers on all TAs which the user plane bearers of the UE are in or all eNBs, and may transfer out an existing UE bearer on the SeNB's cell. When receiving an instruction from the MME that it is supported to simultaneously establish UE bearers on all TAs which the user plane bearers of the UE are in or all eNBs, the MeNB may simultaneously establish or transfer a UE bearer on corresponding TAs or eNBs.

When the response received by the MeNB and sent by the MME indicates a serving identifier list supported by current SGW, the MeNB may preferably select a SeNB's cell supporting a serving identifier in the serving identifier list when selecting the SeNB's cell for the UE to establish or transfer a UE bearer.

The second method for maintaining service continuity in heterogeneous communication system is terminated.

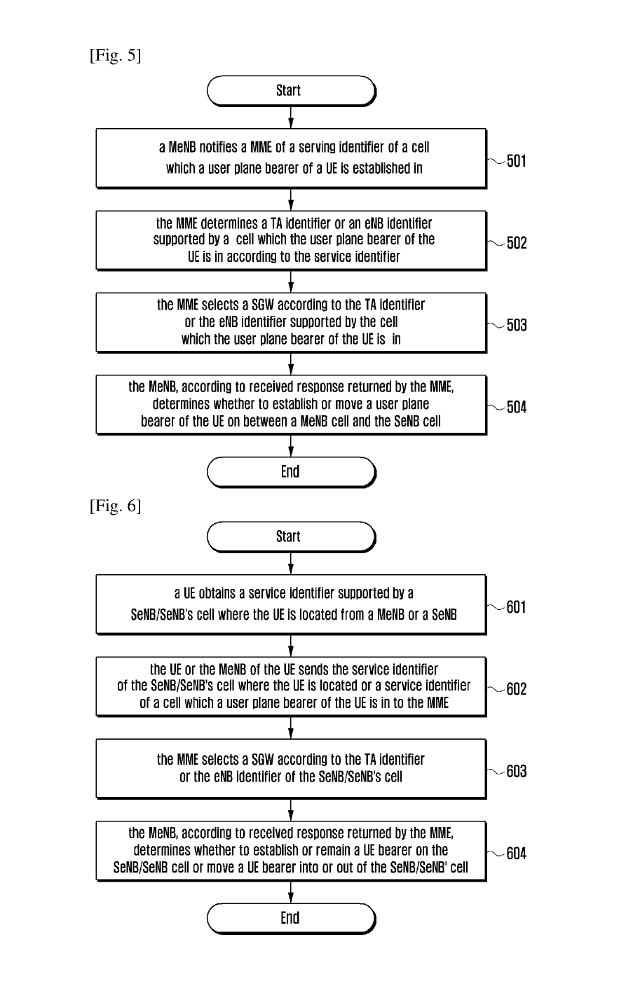

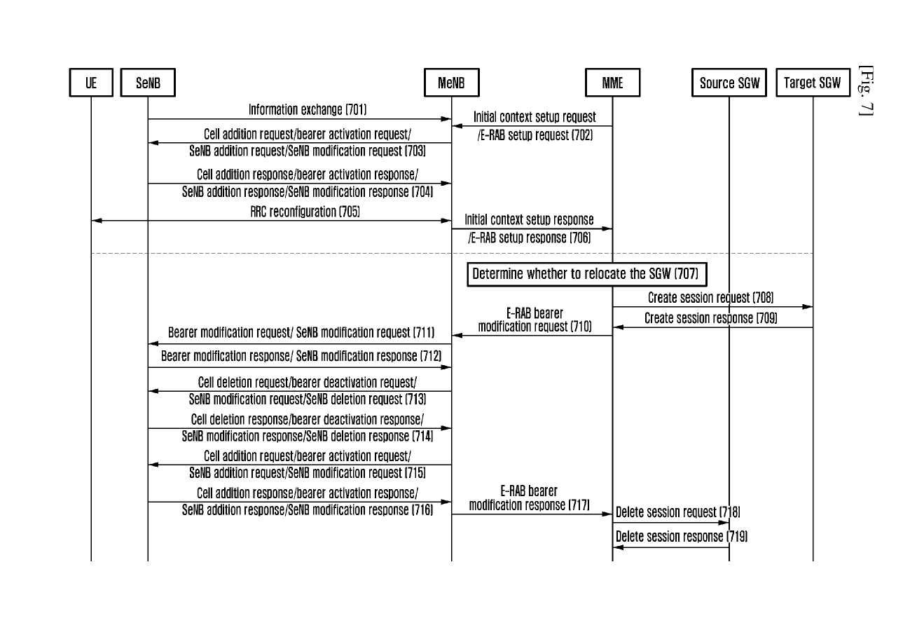

FIG. 6 is a flowchart illustrating a method for maintaining service continuity in heterogeneous communication system according to yet another embodiment of the present disclosure. As shown in FIG. 6, the method includes the following operations.

In block 601, a UE obtains a serving identifier supported by a SeNB/SeNB's cell where the UE is located from a MeNB or a SeNB. The serving identifier may be a TA identifier, a cell identifier or an eNB identifier.

The method for obtaining, by the UE, the serving identifier supported by the SeNB/SeNB's cell from the MeNB may include the following. When receiving a add Scell configuration or add SeNB's cell configuration sent by the MeNB, the UE may simultaneously receive a serving identifier of the SeNB/SeNB's cell.

The method for obtaining, by the UE, the serving identifier supported by the SeNB/SeNB's cell from the SeNB may include the following. When receiving a add Scell configuration or add SeNB's cell configuration sent by the MeNB, the UE may index system informations broadcasted by a cell of the SeNB according to a received physical cell identifier (PCI), and obtain the serving identifier of the SeNB's cell.

In block 602, the UE or the MeNB of the UE sends the MME a serving identifier of the SeNB/SeNB's cell where the UE is located or a serving identifier of a cell which a user plane bearer of the UE is in.

When the UE initiates an attach or tracking area update or service request, the MeNB sends the MME an attach request or a tracking area update request or a service request of the UE, and the attach request or the tracking area update request or the service request carries an serving identifier of the SeNB/SeNB's cell where the UE is located and an serving identifier of a MeNB/MeNB Pcell, or the attach request or the tracking area update request of the service request carries an serving identifier of a cell which the user plane bearer of the UE is in.

Or, when the UE initiates an attach or tracking area update or service request, the UE may send the MME the TA identifier/eNB identifier of the SeNB/SeNB's cell obtained by the UE in block 601 and/or the serving identifier of the MeNB/MeNB Pcell where the UE is located.

When the UE initiates a tracking area update, the tracking area update request may include a TA identifier of the MeNB Pcell last visited registered by the UE and/or a TA identifier of the SeNB's cell, and when the UE initiates an attach or tracking area update, it is necessary for the MeNB to send a corresponding attach request or tracking area update request to the MME.

When the MeNB sends the attach request or tracking area update request to the MME, the attach request or the tracking area update request may further carry a TA identifier of a MeNB Pcell where the UE is currently located and a TA identifier of the SeNB's cell where the UE is currently located, or carry a identifier of a TA which a user plane bearer of the UE is in.

In addition, if the SeNB or the MeNB belongs to the local home network, when the MeNB forwards the attach request or tracking area update request, the attach request or tracking area update request may further carry a local home network identifiers of the MeNB Pcell and the SeNB where the UE is located, so that the MME may, according to a TA of the UE and the local home network which the UE accesses to, determine whether the UE moves out of the local home network and whether it is necessary to release the SIPTO@LN bearer.

Furthermore, the MME may configure a TA identifier list for the UE according to the TA of the MeNB/MeNB Pcell of the UE and TA of the SeNB/SeNB's cell where the UE is located, the TA identifier list includes the TA of the MeNB/MeNB Pcell of the UE and TA of the SeNB/SeNB's cell where the UE is located; or the MME may configure a TA identifier list for the UE according to the TAs which user plane bearers of the UE are in.

The specific processing in block 603 is the same as that in block 403, and no further descriptions will be given hereinafter.

The specific processing in block 604 may be the same as that described in block 404, and no further descriptions will be given hereinafter.

The third method for maintaining service continuity in heterogeneous communication system is terminated.

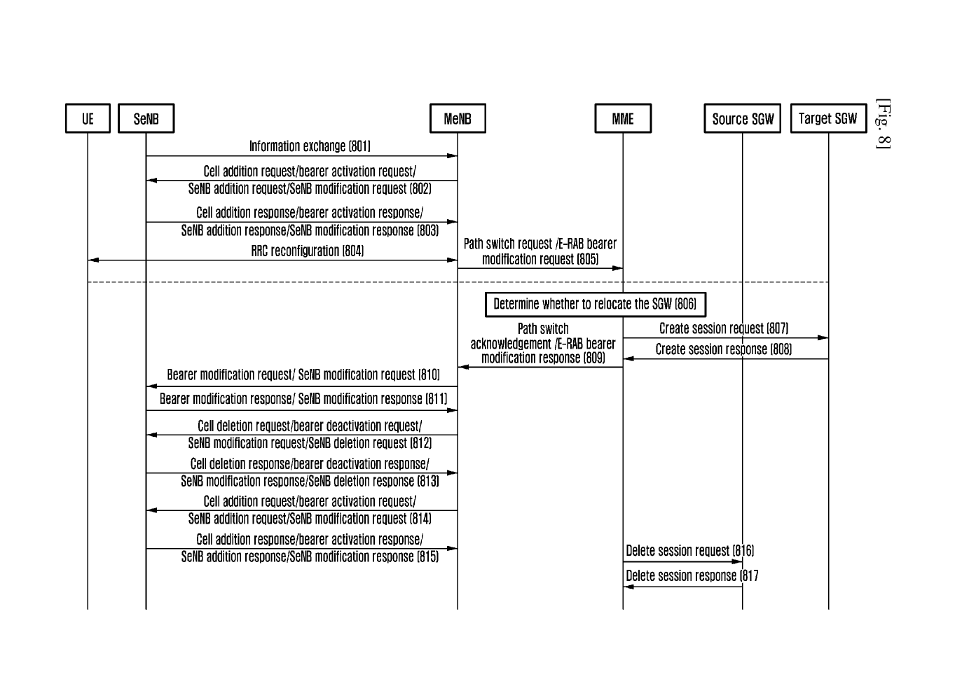

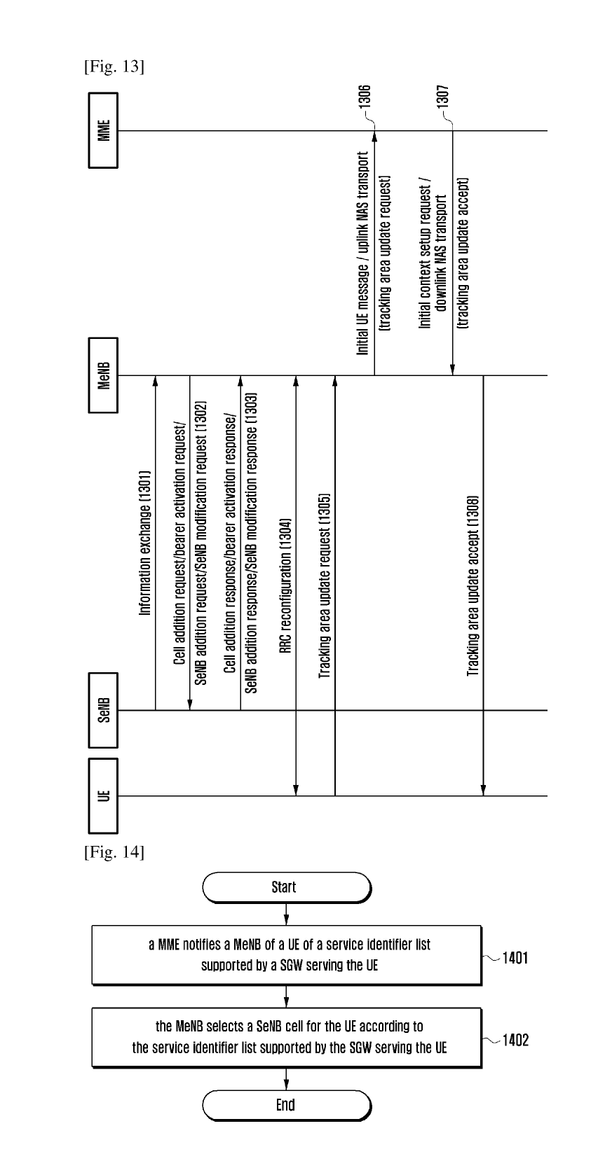

In above mentioned three methods, the MME may obtain serving identifier information of a SeNB/SeNB's cell of the UE, and select a SGW according to the serving identifier of the SeNB/SeNB's cell and/or a serving identifier of a MeNB/MeNB Pcell of the UE, after establishing a session between the MME and the target SGW, the MME may notify the MeNB. Above mentioned methods may be achieved by utilizing existing UE context or a bearer establishment, modification procedure. The serving identifier information of the SeNB/SeNB's cell may be carried in a message of corresponding procedure. The specific processing of above mentioned methods will be described via some examples with reference to accompanying figures. The five examples shown in FIGS. 7 to 11 are used to describe the first and the second method, the two examples shown in FIGS. 12 and 13 are used to describe the third method.

FIG. 7 is a flowchart illustrating a method for maintaining service continuity in heterogeneous communication system according to a first example of the present disclosure. As shown in FIG. 7, the example applies to the scenario that the MeNB directly establishes a bearer on a SeNB's cell.

In step 701, when establishing an interface between a MeNB and a SeNB, the MeNB obtains a serving identifier supported by the SeNB or a SeNB's cell. Or, the MeNB may obtain the serving identifier supported by the SeNB or the SeNB's cell through other methods, such as Operation Administration and Maintenance (OAM) configuration. The serving identifier may be a TA identifier, a cell identifier or an eNB identifier.

In step 702, the MeNB receives an initial context setup request/E-RAB setup request which is sent by the MME and indicates an established user plane bearer of the UE. The MeNB may know a SeNB's cell is available according to the UE measurement, and determine to establish a bearer on the SeNB's cell.

In step 703, the MeNB sends the SeNB a cell addition request/bearer activation request/SeNB addition request/SeNB modification request to indicate the bearer to be established.

In step 704, the SeNB returns a cell addition response/bearer activation response/SeNB addition response/SeNB modification response to the MeNB to indicate a bearer transport layer address and/or a GTP-TEID.

In step 705, the MeNB sends a RRC reconfiguration to the UE to indicate a configuration of an added SeNB's cell, namely a SeNB Scell of the UE.

In step 706, the MeNB returns an initial context setup response/E-RAB setup response to the MME to indicate a serving identifier of the SeNB/SeNB's cell. The serving identifier may be a TA identifier, a cell identifier or an eNB identifier.

When a serving identifier of the SeNB/SeNB's cell is different from a serving identifier of the MeNB/MeNB Pcell, or when the serving identifier of the SeNB's cell is different from a serving identifier which a user plane bearer id in, or when the MeNB obtains a serving identifier list supported by current SGW and knows that the serving identifier of the SeNB/SeNB's cell is not in the serving identifier list supported by the current SGW, the MeNB may indicate a new added serving identifier in the initial context setup response/E-RAB setup response.

Furthermore, the response may further include a local home network identifier of the SeNB/SeNB's cell where the UE is located. The local home network identifier of the SeNB/SeNB's cell where the UE is located may be a local home network identifier of a SeNB/SeNB's cell on which a UE bearer is established by the MeNB, or a local home network identifiers of all SeNBs/SeNB's cells, the MeNB knows, according to a measurement report of the UE, that the UE is in the coverage of the SeNB/SeNB's cell.

In step 707, after receiving a serving identifier of a newly added SeNB/SeNB's cell, the MME determines whether current SGW supports both the serving identifier of the MeNB/MeNB Pcell of the UE and the serving identifier of the newly added SeNB/SeNB's cell or whether current SGW supports both a serving identifier of another existing UE bearer and the serving identifier of a UE bearer on the newly added SeNB's cell, when the current SGW supports, the process is terminated; otherwise, the MME may reselect one SGW supporting both of the serving identifier of the MeNB/MeNB Pcell of the UE and the serving identifier of the newly added SeNB's cell, and proceed to step 708. When there is no SGW supporting both of the serving identifiers, the MME may indicates that the SGW does not support the serving identifier of the newly added SeNB's cell, or selects a SGW supporting the serving identifier of the newly added SeNB's cell and instructs the MeNB to move all bearers into the newly added SeNB's cell, and instructs the MeNB in block 710 to provide a transport layer address of the SGW and/or a GTP-TEID when the SGW is changed; or directly indicates that the serving identifier of the newly added SeNB's cell does not support the bearer; or directly indicates that other bearers are to be moved to a cell corresponding to the serving identifier.

In step 708, the MME sends a create session request to a target SGW.

In step 709, the MME receives a create session response returned by the target SGW.

In step 710, the MeNB receives an E-RAB bearer modification request sent by the MME.

When the MME indicates, in the request, a new transport layer address of the SGW and/or a GTP-TEID, the MeNB may send the transport layer address of the SGW and/or the GTP-TEID to a SeNB on which a UE bearer is established via step 711.

When the MME indicates, in the request, that the SGW does not support the serving identifier of the newly added SeNB, the MeNB may transfer out a bearer on the SeNB/SeNB's cell, for example, transfer the bearer on the SeNB/SeNB's cell onto the MeNB/MeNB Pcell, and delete the bearer resource on the SeNB/SeNB's cell via step 713.

When the MME indicates, in the request, that other bearers are to be moved onto the the cell corresponding to the serving identifier, the MeNB may transfer bearers on other serving identifiers, e.g. bearers on the MeNB/MeNB Pcell, onto the SeNB/SeNB's cell, and notify the SeNB via the step 715.

In step 711, the MeNB send the bearer modification request/SeNB modification request to the SeNB for indicating the transport layer address of the SGW and/or the GTP-TEID.

In step 712, the SeNB returns a bearer modification response/SeNB modification response to the MeNB.

In step 713, the MeNB sends a cell deletion request/bearer deactivation request/SeNB modification request/SeNB deletion request to the SeNB.

In step 714, the SeNB returns a cell deletion response/bearer deactivation response/SeNB modification response/SeNB deletion response to the MeNB.

In step 715, the MeNB sends a cell addition request/bearer activation request/SeNB modification request/SeNB addition request to the SeNB.

In step 716, the SeNB returns a cell addition response/bearer activation response/SeNB modification response/SeNB addition response to the MeNB.

In step 717, the MeNB returns a E-RAB bearer modification response to the MME.

In step 718, the MME sends a delete session request to the source SGW.

In step 719, the MME receives a delete session response returned by the source SGW.

The method according to the first example is terminated. The specific processing described in above mentioned steps 712 to 719 shows only an example for achieving the bearer transfer and modification. In practical application, it is not limited to above mentioned steps 712 to 719 and the corresponding messages, and any processing method capable of achieving the bearer transfer and modification.

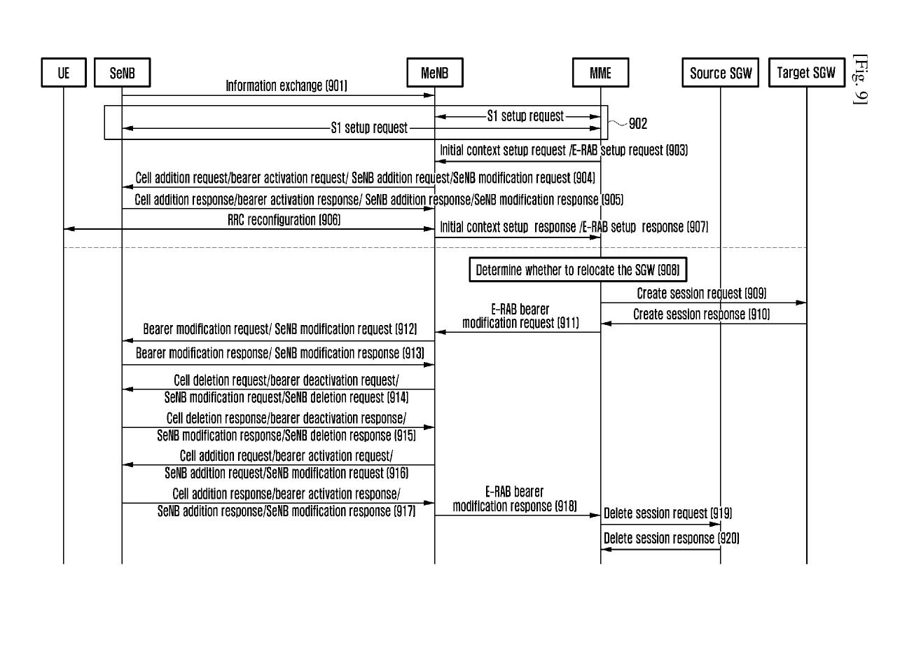

FIG. 8 is a flowchart illustrating a method for maintaining service continuity in heterogeneous communication system according to a second example of the present disclosure. As shown in FIG. 8, the example applies to the scenario that a MeNB transfers a bearer on a MeNB/MeNB Pcell or another SeNB's cell to a target SeNB's cell.

The specific processing in step 801 may be the same as that in step 701, and no further descriptions will be provided hereinafter.

In step 802, the MeNB may know that a SeNB/SeNB's cell is available for the UE according to the UE measurement, and determines to movr a bearer on another eNB/cell to a SeNB/SeNB's cell. The MeNB sends the target SeNB a cell addition request/bearer activation request/SeNB addition request/SeNB modification request to indicate a bearer to be established.

In step 803, the target SeNB returns a cell addition response/bearer activation response/SeNB addition response/SeNB modification response to the MeNB to indicate a bearer transport layer address and/or a GTP-TEID.

In step 804, the MeNB sends a RRC reconfiguration to the UE to indicate a new SeNB/SeNB's cell configuration.

In step 805, the MeNB sends a path switch request or an E-RAB bearer modification request to the MME to indicate a serving identifier of the SeNB/SeNB's cell. The serving identifier may be a TA identifier, a cell identifier or an eNB identifier.

When the serving identifier of the target SeNB/SeNB's cell is different from a serving identifier of the MeNB/MeNB Pcell, or when the serving identifier of the target SeNB/SeNB's cell is different from a serving identifier of a source SeNB/SeNB's cell, or when the MeNB obtains a serving identifier list supported by current SGW and knows that the serving identifier of the SeNB/SeNB's cell is not in the serving identifier list supported by the current SGW, the MeNB may indicate a new added serving identifier in the request.

Furthermore, the request may further include a local home network identifier of the SeNB/SeNB's cell where the UE is located. The local home network identifier of the SeNB/SeNB's cell where the UE is located may be a local home network identifier of a SeNB/SeNB's cell on which a UE bearer is established by the MeNB, or a local home network identifier of a SeNB/SeNB's cell, which the MeNB knowns, according to a measurement report of the UE, that the UE is in the coverage of the SeNB/SeNB's cell.

In step 806, after receiving the serving identifier of the newly added SeNB/SeNB's cell, the MME determines whether the current SGW supports both the serving identifier of the MeNB/MeNB Pcell and the serving identifier of the newly added SeNB/SeNB's cell or whether the current SGW supports both a serving identifier which another existing UE bearer is in and the serving identifier of the newly added SeNB/SeNB's cell, when the current SGW supports, the process is terminated; otherwise, the MME may reselect one SGW supporting both the serving identifier of the MeNB/MeNB Pcell and the serving identifier of the newly added SeNB/SeNB's cell, and proceed to step 807. When there is no SGW supporting both of the two serving identifiers, the MME may indicates that the SGW does not support the serving identifier of the newly added SeNB/SeNB's cell, or selects one SGW supporting the serving identifier of the newly added SeNB/SeNB's cell and instructs the MeNB to move all bearers into the newly added SeNB/SeNB's cell, and instructs the MeNB in block 809 to provide a transport layer address of the SGW and/or a GTP-TEID when the SGW is changed; or indicates that the serving identifier does not support the bearer; or indicates that other bearers should be moved to the serving identifier.

In step 807, the MME sends a create session request to a target SGW.

In step 808, the MME receives a create session response returned by the target SGW.

In step 809, the MeNB receives a path switch acknowledge or an E-RAB bearer modification response sent by the MME.

When the MME, in the request, indicates a new transport layer address of the SGW and/or a GTP-TEID, the MeNB may send the transport layer address of the SGW and/or the GTP-TEID to a SeNB on which a UE bearer is established via step 810.

When the MME indicates, in the request, that the SGW does not support the the serving identifier of the newly added SeNB, the MeNB may transfer out a bearer on the SeNB/SeNB's cell, for example, move the bearer on the SeNB/SeNB's cell onto the MeNB/MeNB Pcell, and delete the bearer resource on the SeNB/SeNB's cell via step 812.

When the MME indicates, in the request, that other bearers are to be moved onto the serving identifier, the MeNB may transfer bearers on other serving identifiers, e.g. bearers on the MeNB/MeNB Pcell, onto the SeNB/SeNB's cell, and notify the SeNB via the step 814.

Steps 810 to 815 are the same as steps 711 to 716, no further descriptions will be provided hereinafter.

In step 816, the MME sends a delete session request to the target SGW.

In step 817, the MME receives a delete session response returned by the target SGW.

The method according to the second example is terminated.

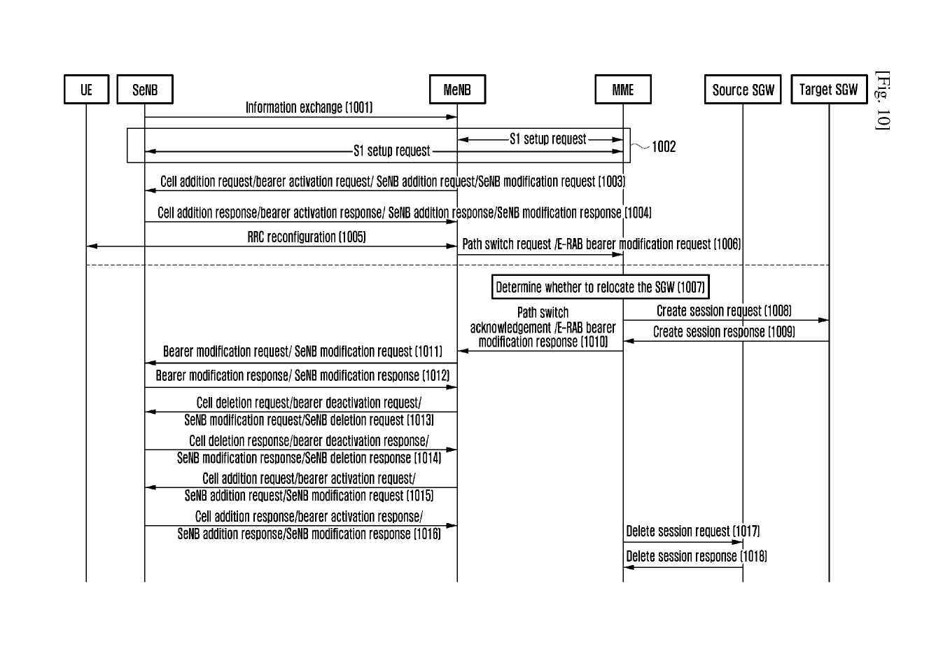

FIG. 9 is a flowchart illustrating a method for maintaining service continuity in heterogeneous communication system according to a third example of the present disclosure. As shown in FIG. 9, the example applies to the scenario that a MeNB transfers a bearer on a MeNB/MeNB Pcell of the UE or another SeNB/SeNB's cell to a SeNB/SeNB's cell.

The specific processing in step 901 may be the same as that in step 701, and no further descriptions will be provided hereinafter.

In step 902, when establishing a S1 interface with a MME, an eNB (including the MeNB and the SeNB) notifies the MME of a mapping relationship between a cell and a serving identifier supported by the cell. The step 902 is an optional step.

In step 903, the MeNB receives an initial context setup request/E-RAB setup request which is sent by the MME and indicates an established user plane bearer of the UE. The MeNB may know a SeNB/SeNB's cell is available for the UE according to the UE measurement, and determine to establish a bearer on the SeNB/SeNB's cell.

In step 904, the MeNB sends the SeNB a cell addition request/bearer activation request/SeNB addition request/SeNB modification request to indicate the bearer to be established.

In step 905, the SeNB returns a cell addition response/bearer activation response/SeNB addition response/SeNB modification response to the MeNB to indicate a bearer transport layer address and/or a GTP-TEID.

In step 906, the MeNB sends a RRC reconfiguration to the UE to indicate a SeNB/SeNB's cell configuration.

In step 907, the MeNB returns an initial context setup response/E-RAB setup response to the MME to indicate a serving identifier of the SeNB/SeNB's cell. The serving identifier may be a TA identifier, a cell identifier or an eNB identifier.

When a serving identifier of the SeNB/SeNB's cell is different from a serving identifier of the MeNB/MeNB Pcell, or when the MeNB obtains a serving identifier list supported by current SGW and knows that the serving identifier of the SeNB/SeNB's cell is not in the serving identifier list supported by the current SGW, the MeNB may indicate a cell identifier of a new added SeNB/SeNB's cell or an eNB identifier in the response.

Furthermore, the response may further include a local home network identifier of the SeNB/SeNB's cell where the UE is located. The local home network identifier of the SeNB/SeNB's cell where the UE is located may be a local home network identifier of a SeNB/SeNB's cell on which a UE bearer is established by the MeNB, or a local home network identifiers of a SeNB/SeNB's cell, which the MeNB knows, according to a measurement report of the UE, that the UE is in the coverage of the SeNB/SeNB's cell.

In step 908, after receiving the cell identifier of the new added SeNB/SeNB's cell or the eNB identifier, the MME may map the cell identifier of the new added SeNB/SeNB's cell or the eNB identifier as a newly added serving identifier, and determine whether current SGW supports both the serving identifier of the MeNB/MeNB Pcell and the serving identifier of the newly added SeNB/SeNB's cell or supports both a serving identifier which another existing UE bearer is in and the serving identifier of the newly added SeNB/SeNB's cell, when the current SGW supports both of the serving identifiers, the process is terminated; otherwise, the MME may reselect one SGW supporting both of the serving identifiers, and proceed to step 909. When there is no SGW supporting both of the serving identifiers, the MME may indicates that the SGW does not support the serving identifier of the newly added SeNB/SeNB's cell, or selects one SGW supporting the serving identifier of the newly added SeNB/SeNB's cell and instructs the MeNB to move all bearers into the newly added SeNB/SeNB's cell, and instructs the MeNB in block 911 to provide a transport layer address of the SGW and/or the GTP-TEID when the SGW is changed; or indicates that the serving identifier does not support the bearer; or indicates that other bearers are to be moved to the serving identifier.

Steps 909 to 920 are the same as steps 708 to 719, no further descriptions will be provided hereinafter.

The method according to the third example is terminated.

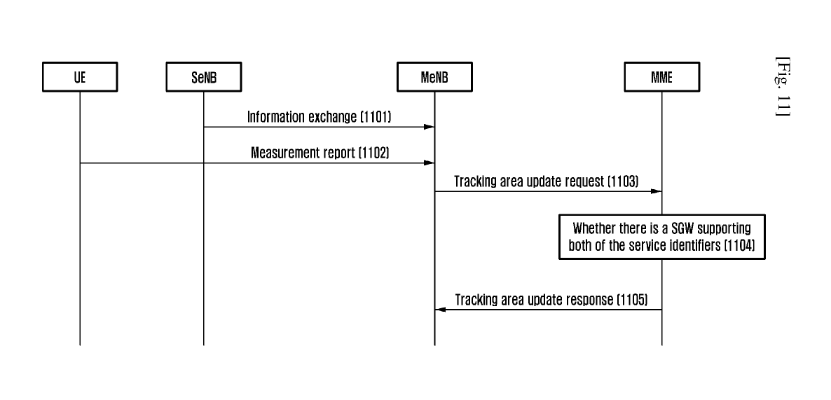

FIG. 10 is a flowchart illustrating a method for maintaining service continuity in heterogeneous communication system according to a fourth example of the present disclosure. As shown in FIG. 10, the example applies to the scenario that a MeNB transfers a bearer on a MeNB/MeNB Pcell of the UE or another SeNB's cell to a SeNB/SeNB's cell.

The specific processing in step 1001 may be the same as that in step 701, and no further descriptions will be provided hereinafter.

In step 1002, when establishing a S1 interface with a MME, an eNB including the MeNB and the SeNB notifies the MME of a mapping relationship between a cell and a serving identifier supported by the cell. The step 1002 is an optional step.

In step 1003, the MeNB may know that a SeNB/SeNB's cell is available according to the UE measurement, and determines to move a bearer on another cell to a SeNB/SeNB's cell of the SeNB. The MeNB sends the SeNB a cell addition request/bearer activation request/SeNB addition request/SeNB modification request to indicate a bearer to be established.

In step 1004, the SeNB returns a cell addition response/bearer activation response/SeNB addition response/SeNB modification response to the MeNB to indicate a bearer transport layer address and/or a GTP-TEID.

In step 1005, the MeNB sends a RRC reconfiguration to the UE to indicate a SeNB/SeNB's cell configuration.

In step 1006, the MeNB sends a path switch request or an E-RAB bearer modification request to the MME to indicate a serving identifier of the SeNB/SeNB's cell. The serving identifier may be a TA identifier, a cell identifier or an eNB identifier.

When the serving identifier of the SeNB/SeNB's cell is different from a serving identifier of the MeNB/MeNB Pcell, or when the MeNB obtains a serving identifier list supported by current SGW and knows that the serving identifier of the SeNB/SeNB's cell is not in the serving identifier list supported by the current SGW, the MeNB may indicate a cell identifier of a new added SeNB/SeNB's cell or an eNB identifier in the response.

Furthermore, the response may further include a local home network identifier of the SeNB/SeNB's cell where the UE is located. The local home network identifier of the SeNB/SeNB's cell where the UE is located may be a local home network identifier of a SeNB/SeNB's cell on which a UE bearer is established by the MeNB, or a local home network identifiers of a SeNB/SeNB's cell, which the MeNB knows, according to a measurement report of the UE, that the UE is in the coverage of the SeNB/SeNB's cell.

In step 1007, after receiving the cell identifier of the new added SeNB/SeNB's cell or the eNB identifier, the MME may map the cell identifier of the new added SeNB/SeNB's cell or the eNB identifier as a newly added serving identifier, and determine whether current SGW supports both the serving identifier of the MeNB/MeNB Pcell and the serving identifier of the newly added SeNB/SeNB's cell or whether current SGW supports both a serving identifier which another existing UE bearer is in and the serving identifier of the newly added SeNB/SeNB's cell, when the current SGW supports both of the serving identifiers, the process is terminated; otherwise, the MME may reselect one SGW supporting both of the serving identifiers, and proceed to step 1008. When there is no SGW supporting both of the serving identifiers, the MME may indicates that the SGW does not support the serving identifier of the newly added SeNB/SeNB's cell, or selects one SGW supporting the serving identifier of the newly added SeNB/SeNB's cell and instructs the MeNB to move all bearers into the newly added SeNB/SeNB's cell, and instructs the MeNB in block 1010 to provide a transport layer address of the SGW and/or the GTP-TEID when the SGW is changed; or indicates that the serving identifier does not support the bearer; or indicates that other bearers are to be moved to the serving identifier.

Steps 1008 to 1018 are the same as steps 807 to 817, no further descriptions will be provided hereinafter.

The method according to the fourth example is terminated.

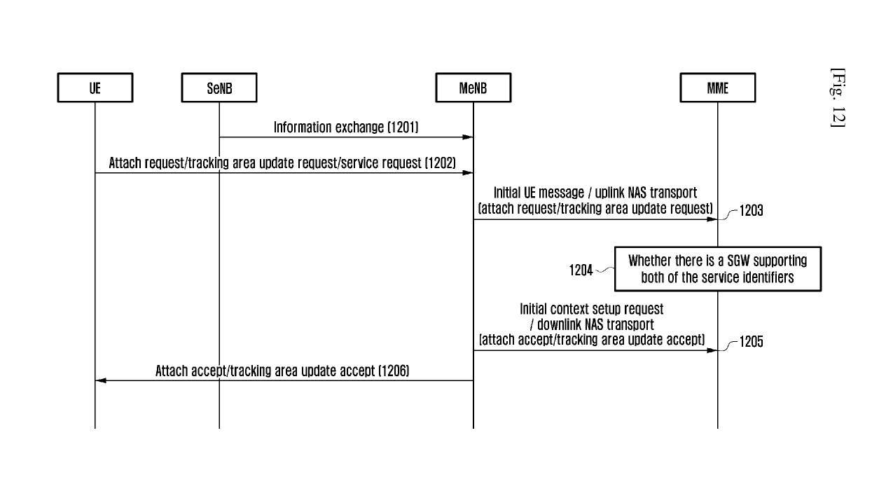

FIG. 11 is a flowchart illustrating a method for maintaining service continuity in heterogeneous communication system according to a fifth example of the present disclosure. As shown in FIG. 11, the example applies to the scenario that a MeNB transfers a bearer on a MeNB/MeNB Pcell of the UE or another SeNB/SeNB's cell to a SeNB/SeNB's cell to trigger a UE tracking area update.

The specific processing in step 1101 may be the same as that in step 701, and no further descriptions will be provided hereinafter.

In step 1102, the MeNB receives a UE measurement report, and finds out a serving identifier of a SeNB/SeNB's cell according to a cell identifier in the measurement report. When the serving identifier of the SeNB/SeNB's cell is different from the serving identifier of the MeNB/MeNB Pcell of the UE, or when the MeNB obtains a serving identifier list supported by current SGW and knows that the serving identifier of the SeNB/SeNB's cell is not in the serving identifier list supported by the current SGW, the MeNB may initiate a tracking area update request.

In step 1103, the MeNB sends a tracking area update request to the MME, the tracking area update request includes the serving identifier of a MeNB/MeNB Pcell which the UE currently accesses to and the serving identifier of the SeNB/SeNB's cell where the UE is located. The SeNB/SeNB's cell where the UE is located may be a SeNB/SeNB's cell, which the MeNB knows, according to a measurement report of the UE, that the UE is in the coverage of the SeNB/SeNB's cell.

In step 1104, after receiving the serving identifier of the MeNB/MeNB Pcell and a serving identifier list including serving identifiers of multiple SeNB(s)/SeNB's cells in the coverage of the MeNB/MeNB Pcell, the MME determines whether current SGW supports both the serving identifier of the MeNB/MeNB Pcell and the serving identifier of the SeNB/SeNB's cell, when the current SGW supports both the serving identifier of the MeNB/MeNB Pcell and the serving identifier of the SeNB/SeNB's cell, the MME may return a support instruction for indicating that the current SGW supports both of the serving identifiers to the MeNB; otherwise, the MME may return an un-support instruction to the MeNB. Furthermore, the MME may further indicate a scope of serving identifier of the current SGW.

In step 1105, the MeNB receives a S1 message carrying a tracking area update response returned by the MME, and according to the support instruction returned by the MME, the MeNB may simultaneously establish a user bearer on the MeNB/MeNB Pcell of the UE and the SeNB/SeNB's cell of the UE; according to the un-support instruction, the MeNB cannot establish a user bearer on the MeNB/MeNB Pcell and the SeNB/SeNB's cell at the same time. The S1 message may be an initial UE context setup request, a downlink NAS transport. The S1 message carries contents instructed in step 1104.

The method according to the fifth example is terminated.

FIG. 12 is a flowchart illustrating a method for maintaining service continuity in heterogeneous communication system according to a sixth example of the present disclosure. As shown in FIG. 12, the example applies to the scenario of UE attachment, tracking area update and service request. There are two means for notifying the MME of a serving identifier of a MeNB/MeNB Pcell of the UE and/or serving identifier(s) of SeNB(s)/SeNB's cell(s). The first means: the UE may notify the MME of the serving identifier of the MeNB/MeNB Pcell of the UE and/or the serving identifier(s) of the SeNB(s)/SeNB's cell(s) via an attach request, a tracking area update request or a service request sent by the UE in step 1202. The second means: the MeNB may notify the MME of the serving identifier of the MeNB/MeNB Pcell of the UE and/or the serving identifier(s) of the SeNB(s)/SeNB's cell(s) in step 1203.

The specific processing in step 1201 may be the same as that in step 701, and no further descriptions will be provided hereinafter.

In step 1202, a UE sends an attach request, a tracking area update request or a service request to the MeNB.

The attach request, tracking area update request or service request may carry the serving identifier of the MeNB/MeNB Pcell of the UE and/or the serving identifier(s) of the SeNB(s)/SeNB's cell(s). The serving identifier may be a TA identifier, a cell identifier or an eNB identifier. The SeNB(s)/SeNB's cell(s) may be all SeNBs/SeNB's cells in the coverage of the MeNB/MeNB Pcell or may be SeNB(s)/SeNB's cell(s) which the UE may access to according to a UE measurement. Above mentioned means for notifying the MME of the serving identifier of the MeNB/MeNB Pcell of the UE and/or the serving identifier(s) of the SeNB(s)/SeNB's cell(s) is the first means.

In step 1203, the MeNB forwards the attach request or the tracking area update request of the UE to the MME via an initial UE message or an uplink NAS transport.

When the serving identifier of the MeNB/MeNB Pcell is different from the serving identifier(s) of the SeNB(s)/SeNB's cell(s) in the coverage of the serving identifier of the MeNB/MeNB Pcell, the MeNB may notify the MME of the serving identifier of the MeNB/MeNB Pcell of the UE and a list of serving identifiers of multiple SeNBs/SeNB's cells in the coverage of the serving identifier of the MeNB/MeNB Pcell, namely the second means for notifying the MME of the serving identifier of the MeNB/MeNB Pcell of the UE and/or the serving identifier(s) of the SeNB(s)/SeNB's cell(s).

In step 1204, after receiving the serving identifier of the MeNB/MeNB Pcell and the serving identifier(s) of the SeNB(s)/SeNB's cell(s) in the coverage of the serving identifier of the MeNB/MeNB Pcell, the MME determines whether current SGW supports both the serving identifier of the MeNB/MeNB Pcell and the serving identifier(s) of the SeNB(s)/SeNB's cell(s), when the current SGW supports both the serving identifier of the MeNB/MeNB Pcell and the serving identifier(s) of the SeNB(s)/SeNB's cell(s), the MME may return a support instruction for indicating that the current SGW supports both the serving identifier of the MeNB/MeNB Pcell and the serving identifier(s) of the SeNB(s)/SeNB's cell(s) to the MeNB; otherwise, the MME may reselect one SGW supporting both the serving identifier of the MeNB/MeNB Pcell and the serving identifier(s) of the SeNB(s)/SeNB's cell(s); or the MME may return serving identifier(s) supported by the current SGW to the MeNB; or the MME may return supported serving identifier(s) of SeNB(s)/SeNB's cell(s) which is(are) served by the same SGW which serves the MeNB/MeNB Pcell or return unsupported serving identifier(s) of SeNB(s)/SeNB's cell(s) which is(are) served by the same SGW which serves the MeNB/MeNB Pcell.

When there is no SGW supporting both the serving identifier of the MeNB/MeNB Pcell and the serving identifier(s) of the SeNB(s)/SeNB's cell(s), the MME may select one SGW according to the serving identifier of the MeNB/MeNB Pcell. The MME may send a serving identifier list supported by selected SGW to the SeNB. Or the MME may notify the MeNB that which serving identifiers are supported by the selected SGW and which serving identifiers are not supported by the selected SGW.

In step 1205, the MME sends an initial context setup request or an downlink NAS transport to the MeNB, the initial context setup request or the downlink NAS transport may include a serving identifier list supported or unsupported by the SGW selected by the MME.

In step 1206, the MeNB receives the initial UE context message or the downlink NAS transport sent by the MME, and sends the UE an attach accept or a tracking area update accept included in the initial UE context message or the downlink NAS transport. When the initial UE context message or the downlink NAS transport includes serving identifier list supported or unsupported by the SGW selected by the MME, the MeNB may move a bearer on an eNB/cell corresponding to a serving identifier unsupported by the SGW onto an eNB/cell corresponding to a serving identifier supported by the SGW or establish a bearer on an eNB/cell corresponding to a serving identifier supported by the SGW. Or, for the supported serving identifier(s), the MeNB may simultaneously establish a UE bearer on the MeNB/MeNB Pcell and SeNB(s)/SeNB's cell(s) corresponding to the supported serving identifier(s); for the unsupported serving identifier(s), the MeNB cannot simultaneously establish a UE bearer on the MeNB/MeNB Pcell and SeNB(s)/SeNB's cell(s) corresponding to the unsupported serving identifier(s).

The method according to the sixth example is terminated.

FIG. 13 is a flowchart illustrating a method for maintaining service continuity in heterogeneous communication system according to a seventh example of the present disclosure. As shown in FIG. 13, the example applies to the scenario that a MeNB transfers a bearer on a MeNB Pcell of the UE or another SeNB's cell to a SeNB/SeNB's cell to trigger a UE tracking area update.

The specific processing in step 1301 may be the same as that in step 701, and no further descriptions will be provided hereinafter.

In step 1302, the MeNB sends the SeNB a cell addition request/bearer activation request/SeNB addition request/SeNB modification request to indicate a bearer to be established.

In step 1303, the SeNB returns a cell addition response/bearer activation response/SeNB addition response/SeNB modification response to the MeNB to indicate a bearer transport layer address and/or a GTP-TEID.

In step 1304, the MeNB sends a RRC reconfiguration to the UE to indicate a SeNB/SeNB's cell configuration including a serving identifier of a SeNB/SeNB's cell.

In step 1305, when the serving identifier of the SeNB/SeNB's cell is not in a serving identifier list of the UE, the UE sends a tracking area update request to the MME. The tracking area update request includes a serving identifier of a MeNB/MeNB Pcell last visited registered by the UE and a serving identifier of the SeNB/SeNB's cell.

In step 1306, the MeNB forwards the tracking area update request of the UE to the MME via an initial UE message or an uplink NAS transport. The initial UE message or the uplink NAS transport carries the serving identifier of the MeNB/MeNB's Pcell where the UE is located and the service identifier of the SeNB/SeNB's cell or a serving identifier which a user plane bearer of the UE is in.

In step 1307, the MME configures a serving identifier list for the UE according to the serving identifier of the MeNB/MeNB Pcell and the serving identifier of the SeNB/SeNB's cell. The serving identifier list includes the serving identifier of the MeNB/MeNB Pcell of the UE where the UE is located and the serving identifier of the SeNB/SeNB's cell. The MME generates a tracking area update accept, and forwards the tracking area update accept to the UE via the eNB.

In step 1308, the MeNB receives an initial UE context message or a downlink NAS transport sent by the MME, and sends the tracking area update accept message to the UE.

The method according to the seventh example is terminated.

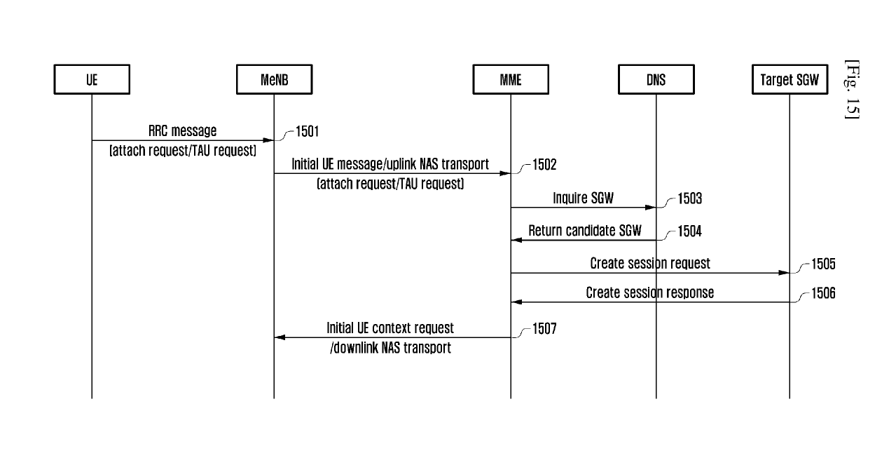

FIG. 14 is a flowchart illustrating a method for maintaining service continuity in heterogeneous communication system according to yet another embodiment of the present disclosure. As shown in FIG. 14, the method includes the following operations.

In block 1401, a MME notifies a MeNB of a UE of a serving identifier list supported by a SGW serving the UE.

In a UE attachment procedure, the MME may query a DNS according to a serving identifier of a cell attached to by the UE, and the DNS may return a candidate SGW and a serving identifier list supported by the candidate SGW. The serving identifier may be a TA identifier of the cell, a cell identifier or an eNB identifier. The MME selects a serving SGW for the UE, and sends a serving identifier list supported by the serving SGW to the MeNB of the UE. The MME may send the MeNB the serving identifier list via a UE context setup request.

In a UE service request procedure or a TAU or handover procedure, the MME may reselect a SGW for the UE according to a new TA of a target cell. When a SGW switch occurs, the MME may send a serving identifier list supported by a new SGW to the MeNB of the UE. The MME may send the MeNB the serving identifier list via a NAS transport, a handover request, a path switch request acknowledge, or a UE context modification request.

When the DNS feeds the candidate SGW back to the MME, the DNS may return a serving identifier list supported by each candidate SGW to the MME.

The MeNB may send an instruction to the MME for requesting the MME to perform the operation of sending the serving identifier list supported by the serving SGW.

Alternatively, the MME determines whether to notify an eNB of the UE of the serving identifier list supported by the SGW serving the UE according to the capacity that whether the UE or eNB supports the dual-connectivity. When the eNB supports the dual-connectivity, the eNB is a MeNB, otherwise, the eNB is an ordinary eNB. For the UE or eNB supporting the dual-connectivity, the MME may send the serving identifier list supported by the serving SGW to the MeNB of the UE.

The MME may know whether the MeNB supports the capacity of providing dual-connectivity for the UE through the following two methods.

1) The MME may know whether the MeNB supports the capacity of providing dual-connectivity for the UE through the operation administration and maintenance (OAM).

2) The MeNB of the UE may notify the MME that whether the MeNB supports the capacity of providing dual-connectivity for the UE via a S1 interface setup request, a initial UE message, a uplink NAS transport, a handover required or a path switch request. The MeNB may directly indicate that whether to support the dual-connectivity, or indirectly indicate by requesting a serving identifier list of the SGW.

In block 1402, the MeNB selects a SeNB or a SeNB's cell for the UE according to the serving identifier list supported by the SGW serving the UE.

After receiving the serving identifier list supported by the SGW serving the UE which is sent by the MME, the MeNB may store the serving identifier list in the UE context. When selecting a SeNB/SeNB's cell for the UE, the MeNB may only select, from candidate SeNBs/SeNB's cells, a SeNB/SeNB's cell supporting a serving identifier in the serving identifier list to establish a user plane bearer of the UE.

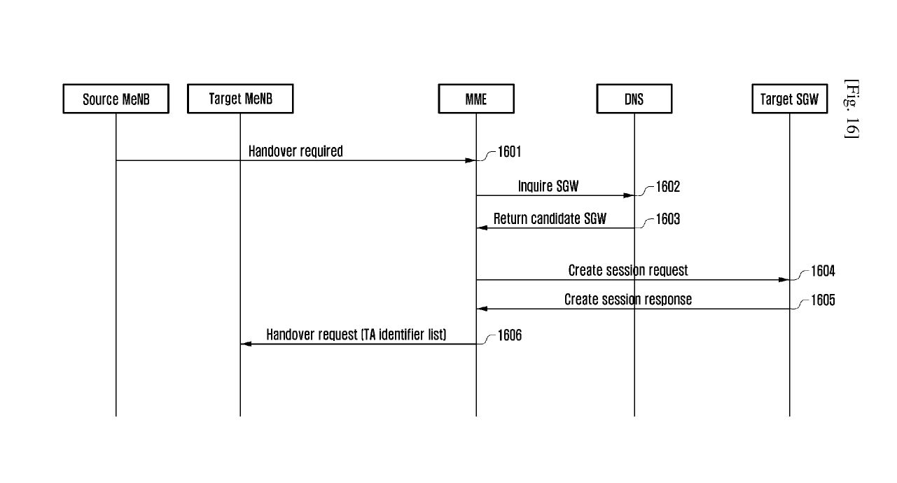

FIG. 15 is a flowchart illustrating a method for maintaining service continuity in heterogeneous communication system according to an eighth example of the present disclosure.

In step 1501, a UE requests to establish a RRC connection with an eNB, and initiates an attach request, a TAU request or a service request.

In step 1502, the eNB sends the attach request via an initial UE message or an uplink NAS transport. In the initial UE message or the uplink NAS transport, it may be indicated that whether the MeNB supports the dual-connectivity or a request for obtaining the serving identifier list supported by the serving SGW may be carried. The serving identifier may be a TA identifier, a cell identifier or an eNB identifier.

In step 1503, the MME inquires a SGW which may be accessed to from a DNS according to a serving identifier of a cell/eNB which the UE accesses to in the initial UE message or the uplink NAS transport. The serving identifier may be a TA identifier, a cell identifier or an eNB identifier.

In step 1504, the DNS returns at least one candidate SGW and a serving identifier list supported by each candidate SGW to the MME. The serving identifier may be a TA identifier, a cell identifier or an eNB identifier.

In step 1505, the MME selects one SGW from the at least one candidate SGW, and sends a create session request to the target SGW.

In step 1506, the target SGW returns a create session response to the MME.

In step 1507, the MME sends the eNB an initial context setup request or a downlink NAS transport. The initial context setup request or the downlink NAS transport includes a serving identifier list supported by the SGW serving the UE. After receiving the serving identifier list supported by the SGW serving the UE, the MeNB may store the serving identifier list in the UE context. The serving identifier may be a TA identifier, a cell identifier or an eNB identifier.

When selecting a SeNB/SeNB's cell for the UE, the MeNB may only select, from candidate SeNB/SeNB's cells, a SeNB/SeNB's cell supporting a serving identifier in the serving identifier list to establish a user plane bearer of the UE.

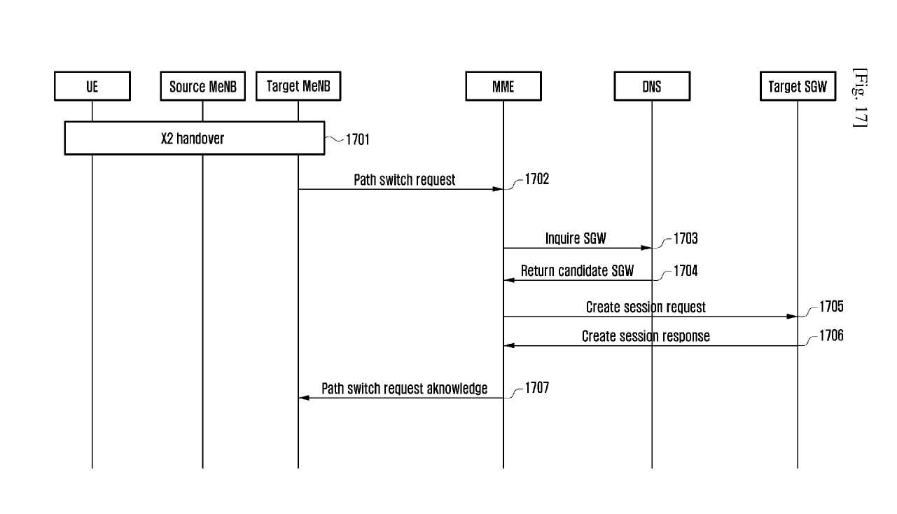

FIG. 16 is a flowchart illustrating a method for maintaining service continuity in heterogeneous communication system according to a ninth example of the present disclosure.

In step 1601, a source MeNB sends a handover required to a MME. In the handover required, it may be indicated that whether the MeNB supports the dual-connectivity or a request for obtaining the serving identifier list supported by the serving SGW may be carried. The serving identifier may be a TA identifier, a cell identifier or an eNB identifier.

In step 1602, the MME inquires a SGW which may be accessed to from a DNS according to a serving identifier of a target cell/eNB of the UE in the handover required. The serving identifier may be a TA identifier, a cell identifier or an eNB identifier.

Steps 1603 to 1605 are the same as steps 1504 to 1506, no further descriptions will be provided hereinafter.

In step 1606, the MME sends a handover request, an initial context setup request, or a downlink NAS transport to the target MeNB. The handover request, initial context setup request, or downlink NAS transport includes a serving identifier list supported by the SGW serving the UE. The serving identifier may be a TA identifier, a cell identifier or an eNB identifier.

After receiving the serving identifier list supported by the SGW serving the UE which is sent by the MME, the MeNB may store the serving identifier list in the UE context. When selecting a SeNB/SeNB's cell for the UE, the MeNB may only select, from candidate SeNB/SeNB's cells, a SeNB/SeNB's cell supporting a serving identifier in the serving identifier list to establish a user plane bearer of the UE.

FIG. 17 is a flowchart illustrating a method for maintaining service continuity in heterogeneous communication system according to a tenth example of the present disclosure.

In step 1701, an X2 handover is performed on the UE between a source MeNB and a target MeNB.

In step 1702, the target MeNB sends a path switch request to the MME. In the path switch request, it may be indicated that whether the MeNB supports the dual-connectivity or a request for obtaining the serving identifier list supported by the serving SGW may be carried. The serving identifier may be a TA identifier, a cell identifier or an eNB identifier.

In step 1703, the MME inquires a SGW which may be accessed to from a DNS according to a serving identifier of a target cell/eNB of the UE in the path switch request. The serving identifier may be a TA identifier, a cell identifier or an eNB identifier.

Steps 1704 to 1706 are the same as steps 1504 to 1506, no further descriptions will be provided hereinafter.

In step 1707, the MME sends a path switch request acknowledge to the target MeNB. The path switch request acknowledge includes a serving identifier list supported by the SGW serving the UE. The serving identifier may be a TA identifier, a cell identifier or an eNB identifier.

After receiving the serving identifier list supported by the SGW serving the UE which is sent by the MME, the MeNB may store the serving identifier list in the UE context. When selecting a SeNB/SeNB's cell for the UE, the MeNB may only select, from candidate SeNB/SeNB's cells, a SeNB/SeNB's cell supporting a serving identifier in the serving identifier list to establish a user plane bearer of the UE.

As can be seen from above mentioned examples, the present disclosure may maintain the continuity of user plane data when a bearer is established on or moved to a small cell, thus when a UE moves under the small cell scenario, the proper processing of bearer shunt may be guaranteed. On one hand, the data rate which the UE perceives may be increased, and the user experience may be improved, on the other hand, the data lost may be avoided, and the service continuity may be maintained.

The foregoing description is only preferred embodiments of the present disclosure and is not used for limiting the protection scope thereof. Any modification, equivalent substitution, or improvement made without departing from the spirit and principle of the present disclosure should be in the coverage of the protection scope of the present disclosure.

1. A method for maintaining service continuity in heterogeneous communication system, comprising:
a) sending, by a master eNB (MeNB) of a UE, a mobility management entity, MME, a serving identifier of a secondary eNB (SeNB) or a SeNB's cell where the UE is located, or a serving identifier of an eNB or a cell which a user plane bearer of the UE is on;
b) according to the serving identifier of the SeNB/SeNB's cell, determining, by the MME, a TA identifier or an eNB identifier supported by the SeNB/SeNB's cell where the UE is located; or, according to the serving identifier of the eNB/cell which the user plane bearer of the UE is on, determining, by the MME, a TA identifier or an eNB identifier supported by the eNB/cell which the user plane bearer of the UE is on;
c) according to the TA identifier or the eNB identifier of a SeNB/SeNB's cell where the UE is located, or according to the TA identifier or the eNB identifier supported by the eNB/cell which the user plane bearer of the UE is on, selecting, by the MME, a SGW, and notifying the MeNB of the SGW; and
d) according to a notification sent by the MME, establishing or remaining, by the MeNB, a UE bearer on the SeNB/SeNB's cell; or moving, by the MeNB, a UE bearer onto or out of the SeNB/SeNB's cell.

2-28. (canceled)
